(19) United States
(12) Patent Application Publication
(10) Pub. No.: US 2025/0071862 A1
(43) Pub. Date: Feb. 27, 2025

(54) HEATER, WATER PURIFIER AND HOT AIR BLOWER INCLUDING THE SAME

(71) Applicant: Samsung Electronics Co., Ltd., Suwon-si (KR)

(72) Inventors: Woong HWANG, Suwon-si (KR); Minkyung LEE, Suwon-si (KR); Jeongnam CHEON, Suwon-si (KR)

(21) Appl. No.: 18/733,248

(22) Filed: Jun. 4, 2024

Related U.S. Application Data
(63) Continuation of application No. PCT/KR2024/007156, filed on May 27, 2024.

(30) Foreign Application Priority Data
Aug. 23, 2023 (KR) 10-2023-0110897
Jan. 17, 2024 (KR) 10-2024-0007693

(51) Int. Cl. H05B 3/82; H05B 3/03; H05B 3/14; H05B 3/40

(52) U.S. Cl. CPC H05B 3/82; H05B 3/03; H05B 3/145; H05B 3/40; H05B 2203/021; H05B 2203/022

(57) ABSTRACT

A heater, a water purifier, and a hot air blower comprising the same are provided. The heater is configured to heat a fluid and includes a graphene scroll forming a heating flow path extending between an inlet through which the fluid flows into the heater and an outlet through which the fluid flows out of the heater, and configured to generate heat in response to an electrical current flowing therethrough, and an electrode configured to apply a voltage to the graphene scroll. The electrode includes a first side electrode electrically connected to the graphene scroll, a second side electrode electrically connected to the graphene scroll and opposite to the first side electrode, and an intermediate electrode electrically connected to the graphene scroll and disposed between the first side electrode and the second side electrode.

### CROSS-REFERENCE TO RELATED APPLICATION(S)

This application is a continuation application, claiming priority under § 365 (c), of an International application No. PCT/KR2024/007156, filed on May 27, 2024, which is based on and claims the benefit of a Korean patent application number 10-2023-0110897, filed on Aug. 23, 2023, in the Korean Intellectual Property Office, and of a Korean patent application number 10-2024-0007693, filed on Jan. 17, 2024, in the Korean Intellectual Property Office, the disclosure of each of which is incorporated by reference herein in its entirety.

### TECHNICAL FIELD

The disclosure relates to a water purifier and a hot air blower including a heater.

### BACKGROUND ART

A water purifier is a device that provides drinking water to users by removing harmful substances, which are contained in raw water such as tap water or groundwater, through various water purification methods such as sedimentation, filtration, and disinfection. The water purifier is configured to supply clean water to users by filtering incoming water through one or more water filters.

Based on the form of the water purifiers, the water purifiers may be classified into a direct type that is directly connected to a faucet, and a storage type that puts water in a container and passes the water through a filter. In addition, the water purifiers may be classified into natural filtration type, direct filtration type, ion exchange resin type, distillation type, reverse osmosis type, etc. based on the purification principle or method.

Water that is purified by the water purifier may be discharged through a dispenser and may be used as drinking water or cooking water.

The water purifier may be configured to provide purified water at various temperatures. For example, the water purifier may include a cooler that cools the purified water to provide cold water. In addition, the water purifier may include a heater that heats purified water to provide hot water.

A hot air blower is a device that provides hot air by drawing air, heating the drawn air, and then discharging the heated air. The hot air blower may include a fan and a fan motor for generating air flow, and a heat source for heating the drawn air. The fan, the fan motor, and the heat source may be disposed within a main body of the hot air blower, and when the fan rotates by the operation of the fan motor, air outside the hot air blower may be drawn into the main body, then heated by the heat source, and discharged again from the main body.

The hot air blowers include hair dryers, which are mainly used at home, and industrial hot air blowers. Further, as well as an independent device itself, the hot air blower may be used as a module to heat air inside various devices such as home appliances.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspects of the disclosure are to address at least the above-mentioned problems and/or disadvantages and to provide at least the advantages described below. Accordingly, an aspect of the disclosure is to provide a heater including an improved structure to improve fluid heating efficiency, and a water purifier and a hot air blower including the same.

Another aspect of the disclosure is to provide a heater including an improved structure to reduce power consumption, and a water purifier and a hot air blower including the same.

Another aspect of the disclosure is to provide a heater including an improved structure to improve a rate of temperature change, and a water purifier and a hot air blower including the same.

Another aspect of the disclosure is to provide a heater including an improved structure to allow a shape of a graphene scroll to be stably maintained, and a water purifier and a hot air blower including the same.

Another aspect of the disclosure is to provide a heater including an improved structure to facilitate heat generation control, and a water purifier and a hot air blower including the same.

Another aspect of the disclosure is to provide a heater including an improved structure to increase a flow rate, and a water purifier and a hot air blower including the same.

Additional aspects will be set forth in part in the description which follows and, in part, will be apparent from the description, or may be learned by practice of the presented embodiments.

### Technical Solution

In accordance with an aspect of the disclosure, a heater which is configured to heat a fluid is provided. The heater may include a graphene scroll forming a heating flow path extending between an inlet through which the fluid flows into the heater and an outlet through which a fluid flows out of the heater, and configured to generate heat in response to an electrical current flowing therethrough, and an electrode configured to apply a voltage to the graphene scroll. The electrode may include a first side electrode electrically connected to the graphene scroll, a second side electrode electrically connected to the graphene scroll and opposite to the first side electrode, and an intermediate electrode electrically connected to the graphene scroll and disposed between the first side electrode and the second side electrode.

In accordance with another aspect of the disclosure, a water purifier is provided. The water purifier may include a dispenser configured to provide purified water and a heater configured to heat the purified water. The heater may include a graphene scroll forming a heating flow path extending between an inlet through which purified water flows into the heater and an outlet through which purified water flows out of the heater, and configured to generate heat in response to an electrical current flowing therethrough, and an electrode provided in contact with the graphene scroll so as to apply a voltage to the graphene scroll. The electrode may include a first side electrode electrically connected to the graphene scroll, a second side electrode electrically connected to the graphene scroll and opposite to the first side electrode, and an intermediate electrode electrically connected to the graphene scroll and disposed between the first side electrode and the second side electrode.

In accordance with another aspect of the disclosure, a hot air blower is provided. The hot air blower may include a main body, a fan disposed in the main body, and a heater disposed in the main body and configured to heat air moved by the fan. The heater may include a graphene scroll forming a heating flow path extending between an inlet through which air flows into the heater and an outlet through which air flows out of the heater, and configured to generate heat in response to an electrical current flowing therethrough, and an electrode configured to apply a voltage to the graphene scroll. The electrode may include a first side electrode electrically connected to the graphene scroll, a second side electrode electrically connected to the graphene scroll and opposite to the first side electrode, and an intermediate electrode electrically connected to the graphene scroll and disposed between the first side electrode and the second side electrode.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 schematically illustrates a water purifier according to an embodiment of the disclosure;

FIG. 2 illustrates a dispenser and a heater of the water purifier according to an embodiment of the disclosure;

FIG. 3 is a cross-sectional view illustrating the dispenser and the heater of the water purifier according to an embodiment of the disclosure;

FIG. 4 is a block diagram illustrating some configurations of the water purifier according to an embodiment of the disclosure;

FIG. 5 illustrates the heater included in the water purifier according to an embodiment of the disclosure;

FIG. 6 is a cross-sectional view illustrating a graphene scroll of the heater included in the water purifier according to an embodiment of the disclosure;

FIG. 7 illustrates a graphene sheet forming the graphene scroll of FIG. 5 and electrodes connected to the graphene sheet according to an embodiment of the disclosure;

FIG. 8 is an enlarged view of a portion of the graphene scroll of the water purifier according to an embodiment of the disclosure;

FIG. 9 is an enlarged view of a portion of a graphene scroll of the water purifier according to an embodiment of the disclosure;

FIG. 10 illustrates a heater included in the water purifier according to an embodiment of the disclosure;

FIG. 11 illustrates a graphene sheet forming a graphene scroll of FIG. 10 and electrodes connected to the graphene sheet according to an embodiment of the disclosure;

FIG. 12 illustrates a heater included in the water purifier and including three electrodes according to an embodiment of the disclosure;

FIG. 13 illustrates a graphene sheet forming a graphene scroll of FIG. 12 and electrodes connected to the graphene sheet according to an embodiment of the disclosure;

FIG. 14 illustrates a heater included in the water purifier and including three electrodes according to an embodiment of the disclosure;

FIG. 15 illustrates a graphene sheet forming a graphene scroll of FIG. 14 and electrodes connected to the graphene sheet according to an embodiment of the disclosure;

FIG. 16 illustrates a heater included in the water purifier and including four electrodes according to an embodiment of the disclosure;

FIG. 17 illustrates a graphene sheet forming a graphene scroll of FIG. 16 and electrodes connected to the graphene sheet according to an embodiment of the disclosure;

FIG. 18 illustrates a heater included in the water purifier and including four electrodes according to an embodiment of the disclosure;

FIG. 19 illustrates a graphene sheet forming a graphene scroll of FIG. 18 and electrodes connected to the graphene sheet according to an embodiment of the disclosure;

FIG. 20 is a cross-sectional view illustrating a portion of a water purifier according to an embodiment of the disclosure;

FIG. 21 is a cross-sectional view illustrating a hot air blower according to an embodiment of the disclosure;

FIG. 22 is a block diagram illustrating some configurations of the hot air blower according to an embodiment of the disclosure; and

FIG. 23 is a cross-sectional view illustrating a portion of a hot air blower according to an embodiment of the disclosure.

The same reference numerals are used to represent the same elements throughout the drawings.

### MODES OF THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known function and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”.

In the following detailed description, the terms of “upper portion”, “lower portion”, “upper side”, “lower side” and the like may be defined by the drawings, but the shape and the location of the component is not limited by the term.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

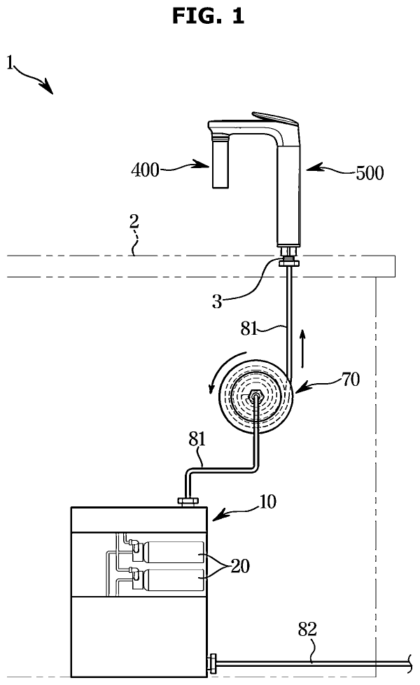

FIG. 1 schematically illustrates a water purifier according to an embodiment of the disclosure.

Referring to FIG. 1, a water purifier 1 according to an embodiment of the disclosure may include a filtering body 10 and a dispenser 500 configured to provide a liquid to the outside of the filtering body 10.

For example, the filtering body 10 may be disposed in a lower portion of a kitchen work table 2. For example, the filtering body 10 may be disposed inside the kitchen work table 2.

For example, the dispenser 500 may be disposed in an upper portion of the kitchen work table 2. According to one embodiment, the dispenser 500 may be rotatably provided on the upper portion of the kitchen work table 2.

For example, an installation member 3 for installing the dispenser 500 may be provided on the kitchen work table 2. The installation member 3 may be formed by opening at least a portion of the kitchen work table 2. For example, the installation member 3 may be formed by opening the upper portion of the kitchen work table 2. The dispenser 500 may be rotatably installed on the installation member 3. The installation member 3 may include various structures configured to allow the dispenser 500 to be installed on the kitchen work table 2.

For example, the kitchen work table 2 may include a sink table. The sink table may include a sink and a kitchen countertop.

The filtering body 10 may be configured to generate purified water by filtering raw water. The filtering body 10 may be configured to generate purified water and deliver the purified water to the dispenser 500.

Particularly, the filtering body 10 may be connected to an external pipe 82 connected to an external water supply source. The filtering body 10 may be connected to an external water supply source through the external pipe 82, and may receive raw water such as tap water from the external water supply source through the external pipe 82. The filtering body 10 may generate purified water by filtering raw water supplied through the external pipe 82.

The filtering body 10 may include at least one filter 20. The filter 20 may be configured to filter raw water to produce purified water. The filter 20 may be configured to separate impurities contained in raw water and generate purified water.

For example, the filter 20 may include a pre-carbon filter configured to adsorb volatile substances such as chlorine and chlorine by-products from raw water, a membrane filter configured to filter out very small contaminants by reverse osmosis, and a post-carbon filter configured to affect taste of purified water that is discharged. At this time, as for the filter 20, the pre-carbon filter, the membrane filter, and the post-carbon filter may be sequentially connected, and the raw water flowing into the filter 20 may be purified by sequentially passing through the pre-carbon filter, the membrane filter, and the post-carbon filter.

In addition, the filter 20 may include various types of filters. Additionally, the plurality of filters 20 may be arranged in the sequence different from the sequence described above.

The dispenser 500 may be configured to discharge the liquid delivered from the filtering body 10. For example, the dispenser 500 may provide purified water. The dispenser 500 may be provided to receive purified water generated from the filtering body 10 and discharge the purified water to the outside. The dispenser 500 may be configured to discharge purified water, which passes through the filter 20, to the outside. The dispenser 500 may be disposed downstream of a flow path from the filter 20.

The dispenser 500 may be connected to the filtering body 10. The dispenser 500 may be connected to the filtering body 10 and receive purified water from the filtering body 10.

The water purifier 1 may include a connection pipe 81 connecting the filtering body 10 and the dispenser 500. One side of the connection pipe 81 may be connected to the filtering body 10 and the other side of the connection pipe 81 may be connected to the dispenser 500. The dispenser 500 may be connected to the filtering body 10 through the connection pipe 81. A flow path, through which purified water flows from the filtering body 10, may be arranged inside the connection pipe 81. Purified water generated in the filtering body 10 may flow to the dispenser 500 through the connection pipe 81.

For example, the dispenser 500 may be connected to the connection pipe 81 through the installation member 3 of the kitchen work table 2.

For example, the water purifier 1 may include a pipe fixing member 70 provided to fix the connection pipe 81. The pipe fixing member 70 may be disposed inside the kitchen work table 2. The pipe fixing member 70 may be disposed between the filtering body 10 and the dispenser 500. The pipe fixing member 70 may be fixed to at least one of the filtering body 10 and the kitchen work table 2. A portion of the connection pipe 81 may be wound around the pipe fixing member 70. A length of the connection pipe 81 may be increased or reduced according to whether a portion of the connection pipe 81 is wound around the pipe fixing member 70. As a result, the dispenser 500 may be configured to be movable with respect to the kitchen work table 2 and/or the filtering body 10.

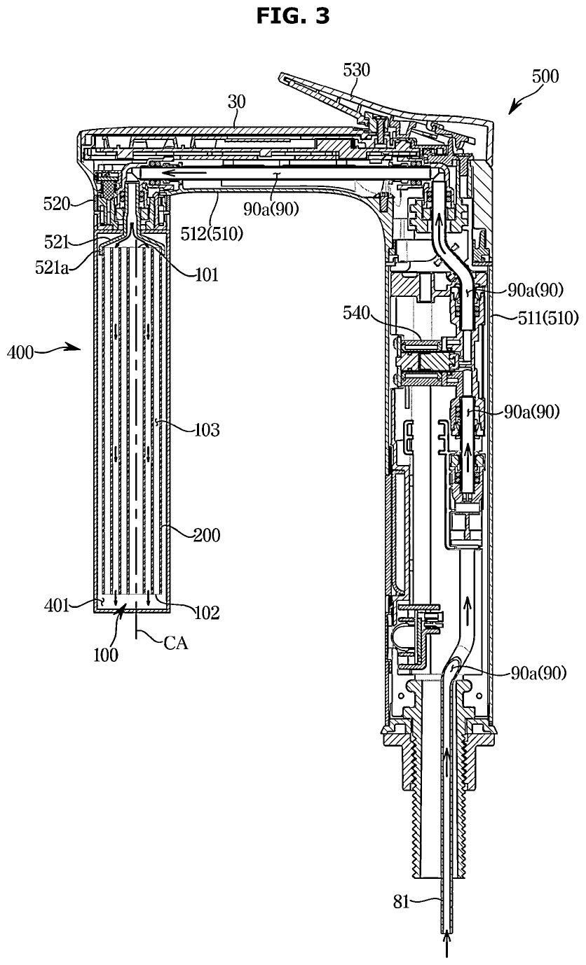

The water purifier 1 may include a filtering flow path 90 (refer to FIG. 3). The filtering flow path 90 may include a flow path through which raw water is filtered to generate purified water. The filtering flow path 90 may include a flow path through which purified water flows.

For example, a portion of the filtering flow path 90 may be disposed inside the filtering body 10. For example, a portion of the filtering flow path 90 may be disposed inside the connection pipe 81. For example, a portion of the filtering flow path 90 may be disposed inside the dispenser 500.

Purified water flowing through the filtering flow path 90 may be discharged to the outside through the dispenser 500.

The configuration of the water purifier 1 described above with reference to FIG. 1 is only an example of the configuration of the water purifier according to the disclosure. The disclosure is not limited thereto, and the water purifier 1 may include various configurations for providing purified water.

Unlike FIG. 1, the water purifier 1 may be used without being installed on the kitchen work table 2. For example, the water purifier 1 may be an independent device in which the dispenser 500 and the filtering body 10 are mounted in a single water purifier case.

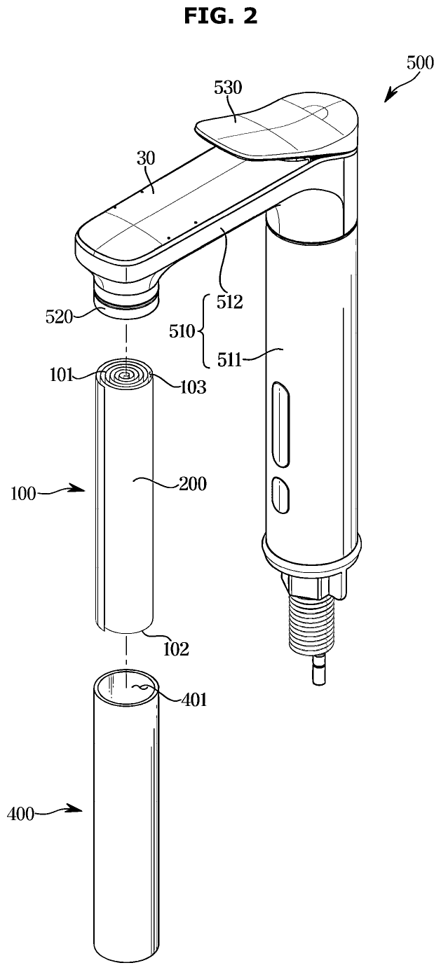

FIG. 2 illustrates a dispenser and a heater of the water purifier according to an embodiment of the disclosure. FIG. 3 is a cross-sectional view illustrating the dispenser and the heater of the water purifier according to an embodiment of the disclosure.

Referring to FIGS. 2 and 3, the dispenser 500 of the water purifier 1 according to an embodiment of the disclosure may include a dispenser body 510 forming an exterior of the dispenser 500. Various components of the dispenser 500 may be disposed in the dispenser body 510.

For example, as illustrated in FIG. 1, one side of the dispenser body 510 may be mounted on the kitchen work table 2. For example, the dispenser body 510 may be rotatably mounted on the kitchen work table 2.

For example, the dispenser body 510 may include a neck 511 extending in a substantially vertical direction and a head 512 extending in a substantially horizontal direction from an upper portion of the neck 511. A lower portion of the neck 511 may be mounted on the kitchen work table 2. The neck 511 may have a shape that stands substantially upward from the kitchen work table 2. Alternatively, the neck 511 may be disposed to be inclined with respect to one surface of the kitchen work table 2 on which the installation member 3 is formed.

For example, the neck 511 and the head 512 may be formed as separate pieces and then coupled to each other. Alternatively, the neck 511 and the head 512 may be formed as one piece.

The dispenser body 510 may be connected to the connection pipe 81. A portion of the connection pipe 81 may be disposed inside the dispenser body 510. A portion of the filtering flow path 90 through which purified water flows may be disposed inside the dispenser body 510.

The filtering flow path 90 may include a dispensing flow path 90a disposed inside the dispenser body 510. The dispensing flow path 90a may be disposed in a portion of the connection pipe 81 disposed inside the dispenser body 510.

The dispenser 500 may include a water outlet 520 provided to discharge a liquid from the dispenser 500. The water outlet 520 may be provided to discharge a liquid flowing along the dispensing flow path 90a. The water outlet 520 may be provided to discharge purified water flowing along the dispensing flow path 90a.

For example, the water outlet 520 may be disposed on the other side of the dispenser body 510, which is opposite to the one side mounted on the kitchen work table 2. One side of the dispensing flow path 90a through which purified water is discharged may be disposed in the water outlet 520.

The dispenser 500 may include a nozzle 521. The nozzle 521 may be provided to discharge a liquid from the dispenser 500. The nozzle 521 may be provided to discharge a liquid flowing along the dispensing flow path 90a. The nozzle 521 may be provided to discharge purified water flowing along the dispensing flow path 90a.

Particularly, the nozzle 521 may be connected to the dispenser body 510. The nozzle 521 may be connected to the connection pipe 81 disposed inside the dispenser body 510. The nozzle 521 may be connected to the dispensing flow path 90a. That is, the nozzle 521 may be connected to the filtering flow path 90. The filtering flow path 90 may extend from the inside of the filtering body 10 to the nozzle 521.

For example, the nozzle 521 may be connected to the dispensing flow path 90a through the water outlet 520.

For example, the nozzle 521 may be mounted on the water outlet 520. Further, the nozzle 521 may be detachably mounted on the water outlet 520. Alternatively, the nozzle 521 may be formed integrally with the water outlet 520.

The nozzle 521 may be provided in such a way that purified water flows into one side thereof connected to the dispensing flow path 90a and the purified water is discharged through the other side thereof opposite to the one side. That is, the nozzle 521 may form a discharge port through which purified water of the dispenser 500 is discharged.

For example, the nozzle 521 may be provided to discharge purified water downward.

The dispenser 500 may include a valve device 540 configured to allow or block the flow of liquid. The valve device 540 may control whether a liquid is discharged through the nozzle 521. For example, the valve device 540 may be configured to open and close the dispensing flow path 90a. The valve device 540 may be disposed on the dispensing flow path 90a.

For example, the valve device 540 may be disposed inside the dispenser body 510. For example, as illustrated in FIG. 3, the valve device 540 may be disposed inside the neck 511.

However, the disclosure is not limited thereto, and the valve device 540 may be disposed in various positions to allow or block the flow of purified water by opening or closing the filtering flow path 90.

The dispenser 500 may include a dispensing lever 530 configured to control the valve device 540. The dispensing lever 530 may control the discharge of liquid through the nozzle 521 by controlling the valve device 540.

The dispenser 500 may include a user interface 30. For example, the user interface 30 may receive a touch input. In addition, the user interface 30 may output an image.

Referring to FIGS. 2 and 3, the user interface 30 may be disposed on an upper surface of the dispenser 500. For example, the user interface 30 may be disposed on the head 512.

Particularly, the head 512 may be formed with an upper portion that is open. At this time, the user interface 30 may be coupled to the open upper portion of the head 512, and various electronic components forming the user interface 30 may be disposed in an internal space of the head 512.

However, the location of the user interface 30 is not limited to the example described above, and the user interface 30 may be disposed in various locations in which settings for discharging liquid, etc. is input from a user.

The user interface 30 will be described later.

The water purifier 1 may be configured to provide purified water at various temperatures. Particularly, the water purifier 1 may be configured to provide purified water of various temperatures based on a user input corresponding to temperature setting of the purified water.

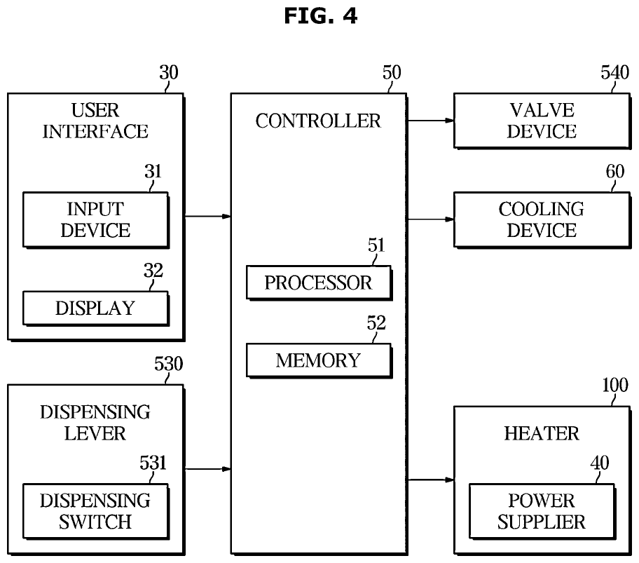

For example, the water purifier 1 may include a cooling device 60 (refer to FIG. 4). The cooling device 60 may be configured to cool a liquid. The cooling device 60 may be configured to cool purified water or raw water according to a location of the cooling device 60.

For example, the cooling device 60 may include a cooling circuit including a compressor, a condenser, an expander, and an evaporator. For example, the cooling device 60 may be disposed in the filtering body 10. However, the disclosure is not limited thereto, and the cooling device 60 may include various types of cooling devices and may be disposed at various locations in the water purifier 1.

Further, the water purifier 1 may include a heater 100. The heater 100 may be configured to heat a liquid. The heater 100 may be configured to heat water. By the heater 100, the water purifier 1 may provide hot water.

The heater 100 may be configured to generate heat. The heater 100 may be configured to heat water by generating heat. The heater 100 may be configured to generate heat based on an applied voltage.

The heater 100 may be disposed on a flow path, through which water flows, in the water purifier 1. The heater 100 may be configured to heat water passing through the heater 100.

Particularly, the heater 100 may include an inlet 101 through which water flows into the heater 100, and an outlet 102 through which water is discharged from the heater 100. Water may flow into the heater 100 through the inlet 101, be heated, and then be discharged from the heater 100 through the outlet 102.

The inlet 101 may be provided on one side of the heater 100. The inlet 101 may be disposed on an upstream side of the heater 100. For example, as illustrated in FIGS. 2 and 3, the inlet 101 may be disposed on one side of the heater 100 adjacent to the nozzle 521.

The outlet 102 may be disposed on the other side opposite to the one side in which the inlet 101 of the heater 100 is located. The outlet 102 may be disposed on a downstream side of the heater 100. For example, as illustrated in FIGS. 2 and 3, the outlet 102 may be disposed on the other side of the heater 100 opposite to the nozzle 521. The outlet 102 may be located in a downstream direction of the flow path from the inlet 101.

For example, a width of the inlet 101 may approximately correspond to a width of the outlet 102. In other words, a cross-sectional area of the inlet 101 may approximately correspond to a cross-sectional area of the outlet 102.

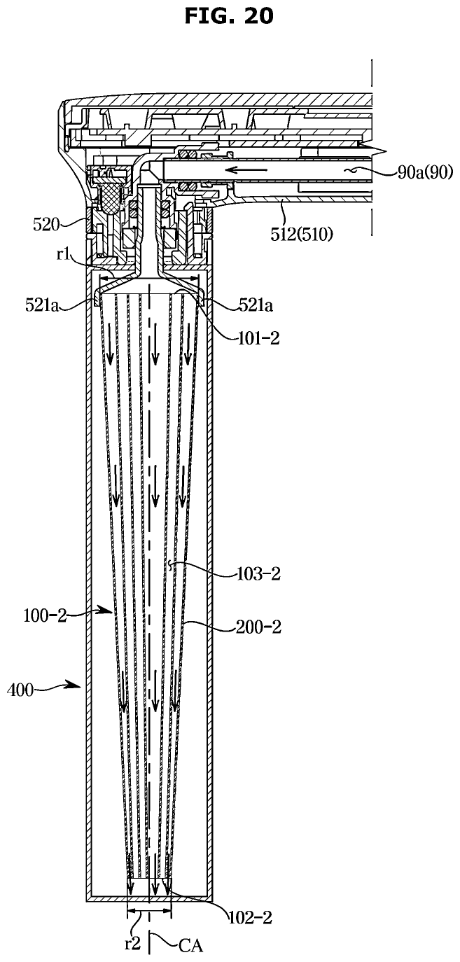

However, the width of the inlet 101 may be different from the width of the outlet 102. For example, the width of the inlet 101 may be greater or less than the width of the outlet 102 (e.g., refer to FIG. 20).

The heater 100 may be formed to have a bar shape extending in one direction. For example, the heater 100 may extend linearly between the inlet 101 and the outlet 102 along a direction in which the inlet 101 and the outlet 102 face each other. However, the disclosure is not limited thereto, and the heater 100 may extend to have a shape in which at least a portion is curved between the inlet 101 and the outlet 102.

The heater 100 may form a heating flow path 103. The heating flow path 103 may form at least a portion of the flow path, through which water flows, in the water purifier 1. When water is provided by the water purifier 1, the water may pass through the heating flow path 103, and the heater 100 may heat the water passing through the heating flow path 103.

The heating flow path 103 may extend between the inlet 101 and the outlet 102 of the heater 100. The heating flow path 103 may be disposed inside the heater 100. The heating flow path 103 may be disposed in a space formed inside the heater 100. An outer circumferential surface of the heater 100 may be formed to have a shape surrounding the heating flow path 103. Heat generated from the heater 100 may be transferred to the heating flow path 103 inside the heater 100 to heat the water flowing along the heating flow path 103. Water flowing into the heater 100 through the inlet 101 may flow along the heating flow path 103 and then be discharged from the heater 100 through the outlet 102.

For example, the heating flow path 103 may extend in one direction, but is not limited thereto. The direction, in which the heating flow path 103 extends, may vary according to the shape of the heater 100, the positions of the inlet 101 and the outlet 102, etc.

The heater 100 may be connected to the filtering flow path 90. The heating flow path 103 may be connected to the filtering flow path 90. Accordingly, the water purifier 1 may provide heated purified water.

For example, the heater 100 may be configured to heat purified water. The heater 100 may be disposed downstream from the filtering flow path 90 to heat purified water. The heating flow path 103 may be disposed downstream from the filtering flow path 90. The heating flow path 103 may be disposed downstream from the dispensing flow path 90a. The inlet 101 of the heater 100 may be disposed downstream from the filtering flow path 90.

As illustrated in FIGS. 2 and 3, the heater 100 may be mounted on the dispenser 500. Particularly, the heater 100 may be mounted on the water outlet 520 of the dispenser 500. Alternatively, the heater 100 may be mounted on the nozzle 521 of the dispenser 500. The heater 100 may be disposed downstream from the nozzle 521 to heat purified water that is discharged from the nozzle 521. The inlet 101 of the heater 100 may be disposed downstream from the nozzle 521, and thus purified water discharged through the nozzle 521 may flow into the heater 100 through the inlet 101.

For example, the heater 100 may be arranged to extend in the vertical direction when mounted on the nozzle 521. In other words, as illustrated in FIGS. 2 and 3, when the heater 100 is mounted on the nozzle 521, the inlet 101 may be disposed on the upper side, the outlet 102 may be disposed on the lower side, and the heating flow path 103 may be arranged to extend in the vertical direction between the inlet 101 and the outlet 102. Accordingly, purified water discharged downward through the nozzle 521 may be heated while flowing downward along the heating flow path 103, and the heated purified water may be discharged downward through the outlet 102.

The nozzle 521 may include a heater mounting portion 521a on which the heater 100 is mounted. For example, the heater mounting portion 521a may be provided to support one side of the heater 100 adjacent to the inlet 101. For example, the heater mounting portion 521a may be provided to support an outer surface of the heater 100. For example, the nozzle 521 may be detachably mounted on the heater mounting portion 521a.

As illustrated in FIGS. 2 and 3, the water purifier 1 may include a heater housing 400 in which the heater 100 is accommodated. The heater housing 400 may cover the outer circumferential surface of the heater 100. The heater 100 may be configured to heat water flowing within the heater housing 400.

For example, when the heater 100 is mounted on the dispenser 500, the heater housing 400 may also be mounted on the dispenser 500. For example, when the heater 100 is mounted on the water outlet 520 or the nozzle 521, the heater housing 400 may also be mounted on the water outlet 520. For example, the heater housing 400 may be detachably mounted on the water outlet 520.

The heater housing 400 may include a heater accommodating portion 401 in which the heater 100 is accommodated. The heater 100 may be disposed inside the heater accommodating portion 401.

The heater housing 400 may be formed in such a way that both ends are open. The heater accommodating portion 401 may be connected to the outside of the heater accommodating portion 401 through the open both ends.

Purified water discharged through the nozzle 521 may flow into the heater accommodating portion 401 through one end of the heater housing 400, and purified water heated by the heater 100 may be discharged from the heater accommodating portion 401 through the other end of the heater housing 400.

For example, the heater housing 400 may have a substantially cylindrical shape with a hollow, but the shape of the heater housing 400 is not limited thereto.

For example, the heater housing 400 may extend in the substantially vertical direction. Correspondingly, the heater accommodating portion 401 may extend in the substantially vertical direction. The heater housing 400 and the heater 100 may extend in parallel directions.

For example, the heater housing 400 may be formed in such a way that an inner circumferential surface of the heater housing 400 is in contact with an outermost circumference of a graphene scroll 200, which will be described later, of the heater 100, to support the graphene scroll 200 from the outside so as to maintain the shape of the graphene scroll 200. Alternatively, the inner circumferential surface of the heater housing 400 and the outermost circumference of the graphene scroll 200 may be spaced apart from each other.

Unlike the above description, the heater 100 may not be directly mounted on the nozzle 521. For example, the heater 100 may be supported by the heater housing 400 and mounted on the water outlet 520 through a structure, in which the heater housing 400 is mounted on the water outlet 520, and then connected to the nozzle 521. For example, the heater housing 400 may be detachably mounted on the water outlet 520, and the heater 100 may be detachably mounted on the heater housing 400. Alternatively, the heater 100 may be detachably mounted directly on the water outlet 520.

Unlike the above description, the heater 100 may be provided in such a way that the heater 100 is not separated from the dispenser 500 after the heater 100 is mounted on the dispenser 500.

In the above, one embodiment, in which the heater 100 is disposed downstream from the filtering flow path 90 and directly heats purified water, is described. However, the arrangement of the heater 100 is not limited thereto. For example, the heater 100 may be disposed on the filtering flow path 90, and particularly, disposed inside the dispenser body 510 to heat the water passing through the dispensing flow path 90a among the filtering flow path 90. Alternatively, the heater 100 may be disposed upstream from the dispensing flow path 90a. Alternatively, the heater 100 may be disposed upstream from the filtering flow path 90. The heater 100 may be arranged upstream from the filter 20 to directly heat raw water.

Accordingly, the water purifier 1 may include the heater 100 so as to provide heated purified water.

FIG. 4 is a block diagram illustrating some configurations of the water purifier according to an embodiment of the disclosure.

Referring to FIG. 4, the water purifier 1 according to an embodiment of the disclosure may include a controller 50 configured to control various configurations of the water purifier 1.

The controller 50 may include a processor 51 configured to generate a control signal related to the operation of the water purifier 1, and a memory 52 configured to store programs, applications, instructions, and/or data for the operation of the water purifier 1. The processor 51 and the memory 52 may be implemented as separate semiconductor devices or as a single semiconductor device.

Further, the controller 50 may include a plurality of processors or a plurality of memories. The controller 50 may be disposed at various locations inside the water purifier 1.

The processor 51 may include an arithmetic circuit, a memory circuit, and a control circuit. The processor 51 may include one chip or a plurality of chips. Additionally, the processor 51 may include one core or a plurality of cores.

The memory 52 may store various programs and data required for control, and temporarily store temporary data generated during control.

The memory 52 may include volatile memory such as Static Random Access Memory (S-RAM) and Dynamic Random Access Memory (D-RAM), and non-volatile memory such as Read Only Memory (ROM) and Erasable Programmable Read Only Memory (EPROM). The memory 52 may include one memory element or may include a plurality of memory elements.

The processor 51 may be electrically connected to the memory 52. The processor 51 may process data and/or signals using a program provided from the memory 52, and may transmit control signals to each configuration of the water purifier 1 based on the processing results. Each configuration of the water purifier 1 may be operated based on a control signal from the processor 51.

For example, electronic components constituting the controller 50 may be disposed inside the dispenser body 510. Alternatively, the controller 50 may be disposed inside the filtering body 10. Further, the controller 50 may be composed of a plurality of modules, and some of the plurality of modules may be disposed inside the dispenser body 510, and other modules may be disposed inside the filtering body 10. However, the disclosure is not limited thereto, and the electronic components constituting the controller 50 may be disposed at various locations in the water purifier 1.

The water purifier 1 may include the user interface 30. For example, the user interface 30 may be disposed on the dispenser 500.

The user interface 30 may include an input device 31 for receiving a user input. Types of user input that are received through the input device 31 may include on/off setting of power of the water purifier 1, setting a dispensed water volume, setting a temperature of purified water (i.e., a degree of heat generation of the heater 100), etc.

For example, the input device 31 may include a room temperature water button configured to obtain a user input that sets the discharge of room temperature purified water through the dispenser 500, a hot water button configured to obtain a user input that sets the discharge of hot water through the dispenser 500, a cold water button configured to obtain a user input that sets the discharge of cold water through the dispenser 500, a dispensed water volume setting button configured to obtain a user input that sets a target amount of liquid discharged through the dispenser 500, or a dispensing button configured to obtain a user input that requests to dispense purified water of a set temperature through the dispenser 500. According to the configuration of the water purifier 1, the input device 31 may include buttons configured to obtain a user input requesting to discharge various types of liquid, as well as purified water.

The input device 31 may include various types of input devices such as a tact switch, a push switch, a slide switch, a toggle switch, a micro switch, or a touch switch.

The input device 31 may be electrically connected to the controller 50. The input device 31 may receive a user input, output an electrical signal (voltage or electrical current) corresponding to the user input, and transmit the electrical signal to the controller 50. The controller 50 may receive a user input based on the output signal of the input device 31.

The user interface 30 may include a display 32 for displaying information related to the operation or status of the water purifier 1.

The information related to the operation or status of the water purifier 1 displayed on the display 32 may include setting information corresponding to the user input (dispensed water volume setting/temperature setting, etc.), operation information of the water purifier 1, etc.

The display 32 may be electrically connected to the controller 50. The display 32 may display setting information corresponding to a user input and/or operation information of the water purifier 1 based on the signal received from the controller 50.

For example, the display 32 may include a liquid crystal display (LCD) panel, a light emitting diode (LED) panel, etc.

However, the configuration of the user interface 30 provided in the water purifier 1 according to the disclosure is not limited thereto, and various types of user interfaces may be provided.

As described above, the water purifier 1 may include the dispensing lever 530. The dispensing lever 530 may be configured to change a position or posture thereof by a physical pressure from a user. The dispensing lever 530 may include a dispensing switch 531 configured to be turned on or off (closed or open) according to the position or posture of the dispensing lever 530. For example, when the dispensing lever 530 is in a first position or a first posture, the dispensing switch 531 may be turned off (or open). When the dispensing lever 530 is moved to a second position or a second posture by a user's physical pressure, the dispensing switch 531 may be turned on (or closed).

The dispensing switch 531 may obtain a user input for requesting to dispense a liquid (e.g., purified water, etc.) through the dispenser 500. The dispensing switch 531 may include a push switch, a micro switch, or a reed switch.

The dispensing switch 531 may output an electrical signal corresponding to the obtained user input and provide the electrical signal to the controller 50. The controller 50 may identify a user input for requesting to dispense a liquid based on the output signal of the dispensing switch 531. The controller 50 may control the valve device 540 to open the dispensing flow path 90a based on the output signal of the dispensing switch 531.

Based on the above description, the dispensing lever 530 may be considered as a type of input device.

As described above, the water purifier 1 may include the valve device 540 configured to open or close the flow path. When the valve device 540 opens the flow path, water may flow along the open flow path. When the valve device 540 closes the flow path, water may not flow along the flow path. For example, the valve device 540 may be configured to open and close the dispensing flow path 90a.

At this time, the controller 50 may control the valve device 540. The controller 50 may be electrically connected to the valve device 540, and the valve device 540 may open or close the flow path based on a control command received from the controller 50. For example, the controller 50 may control the operation of the valve device 540 based on a user input obtained from the input device 31 or the dispensing lever 530.

The valve device 540 may include an electric operated valve (solenoid valve, etc.) configured to open and close the flow path by a driving electrical current (or driving voltage).

As described above, the water purifier 1 may include the cooling device 60. The cooling device 60 may be configured to cool a liquid. For example, the cooling device 60 may be configured to cool purified water. Further, the cooling device 60 may be configured to cool raw water.

As described above, the cooling device 60 may include the cooling circuit. At this time, the compressor constituting the cooling circuit of the cooling device 60 may include a motor. The compressor of the cooling device 60 may circulate a refrigerant in the cooling circuit using the torque of the motor. The cooling device 60 may cool a liquid by the evaporation of the refrigerant circulating in a refrigerant circuit.

The controller 50 may control the cooling device 60. The controller 50 may be electrically connected to the cooling device 60. The controller 50 may control the cooling device 60 to cool water based on a condition for providing cold water. For example, the controller 50 may control the cooling device 60 to cool the liquid by applying a driving electrical current to the motor of the compressor of the cooling device 60.

The heater 100 may include a power supplier 40. The power supplier 40 may be configured to apply a voltage to the graphene scroll 200 of the heater 100. The power supplier 40 may be configured to apply a voltage to an electrode 300 of the heater 100. The power supplier 40 may be electrically connected to the electrode 300 of the heater 100. Particularly, the power supplier 40 may be electrically connected to a plurality of electrodes 300 disposed in the heater 100. The power supplier 40 may be configured to apply or not apply a voltage between the plurality of electrodes 300.

The controller 50 may be electrically connected to the power supplier 40. The controller 50 may control the power supplier 40 to apply or not apply a voltage between the plurality of electrodes 300 based on a predetermined condition.

The predetermined condition may include a user input that is obtained through the input device 31 or the dispensing lever 530. For example, when a user input for discharging hot water is obtained through the input device 31 or the dispensing lever 530, the controller 50 may control the power supplier 40 to allow a voltage to be applied between the plurality of electrodes 300 so as to allow the heater 100 to heat water at a temperature in a predetermined range. when a user input for discharging warm water, room temperature water or cold water is obtained through the input device 31 or the dispensing lever 530, the controller 50 may control the power supplier 40 to allow a voltage not to be applied between the plurality of electrodes 300 or to allow a magnitude of the applied voltage to be reduced.

For example, electronic components constituting the power supplier 40 may be disposed inside the dispenser body 510. However, the disclosure is not limited thereto, and the electronic components constituting the power supplier 40 may be disposed at various locations in the water purifier 1. For example, the electronic components constituting the power supplier 40 may be disposed in the filtering body 10 or may be disposed in a configuration other than the dispenser 500 or the filtering body 10.

The configuration described above with reference to FIG. 4 is only an example of the configuration of the water purifier 1 according to an embodiment of the disclosure, and the disclosure is not limited thereto.

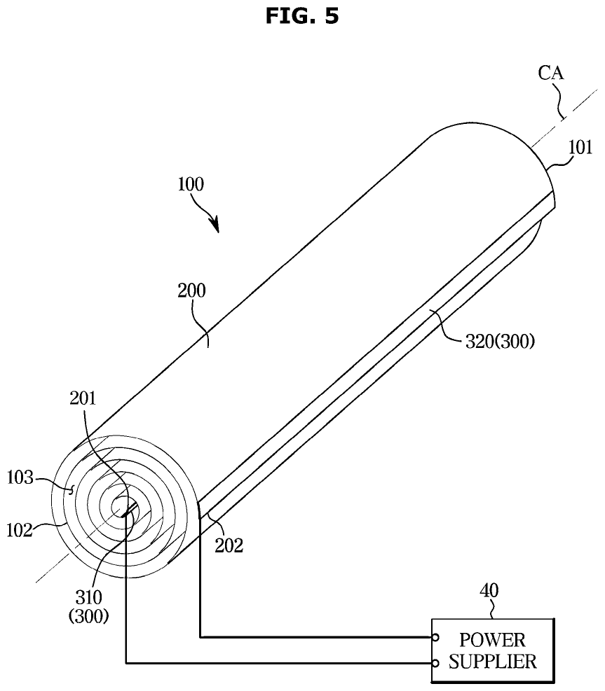

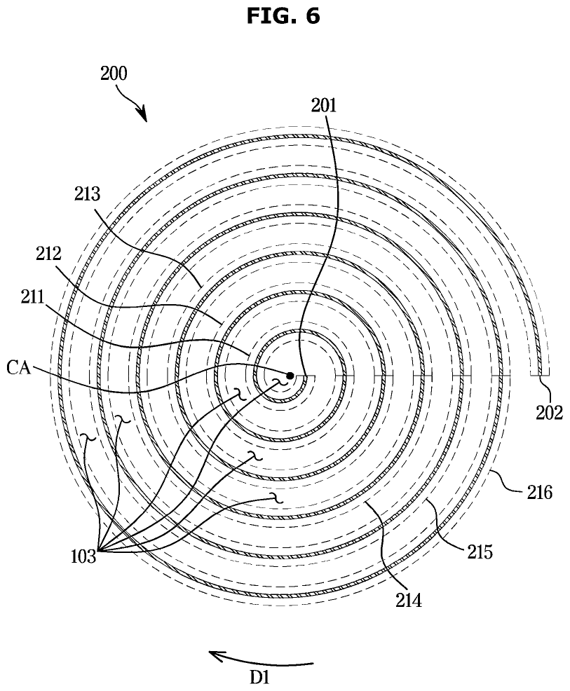

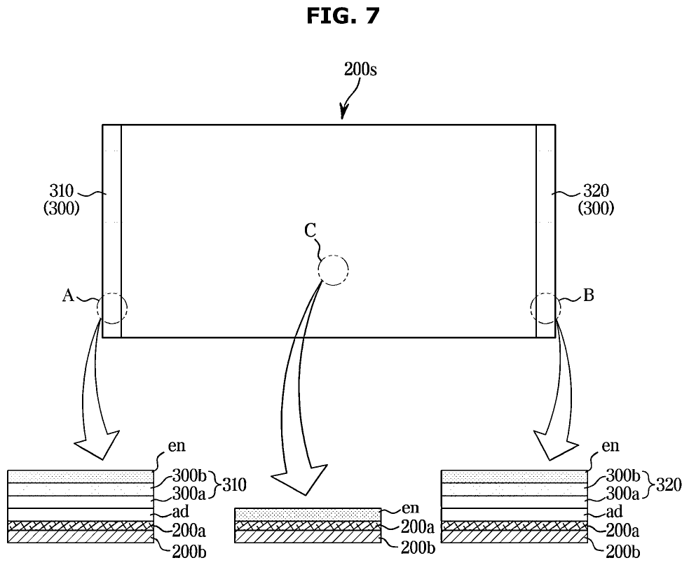

FIG. 5 illustrates the heater included in the water purifier according to an embodiment of the disclosure. FIG. 6 is a cross-sectional view illustrating a graphene scroll of the heater included in the water purifier according to an embodiment of the disclosure. FIG. 7 illustrates a graphene sheet forming the graphene scroll of FIG. 5 and electrodes connected to the graphene sheet according to an embodiment of the disclosure.

Referring to FIGS. 5 to 7, the heater 100 of the water purifier 1 according to an embodiment of the disclosure may include the graphene scroll 200. The graphene scroll 200 may be configured to generate heat. The graphene scroll 200 may be configured to generate heat when an electrical current flows therethrough. The graphene scroll 200 may be configured to heat the liquid passing through the heating flow path 103. The graphene scroll 200 may be configured to heat purified water discharged by the dispenser 500.

The graphene scroll 200 may be formed of a material containing graphene. The graphene scroll 200 may be formed using a graphene sheet 200s (refer to FIG. 7) formed of a material containing graphene. As illustrated in FIG. 7, the graphene sheet 200s may be formed in a substantially planar shape. For example, the graphene sheet 200s may be formed into a thin sheet shape having an approximately rectangular shape. A detailed description of the structure of the graphene sheet 200s will be described later.

Graphene may refer to a thin film laminated approximately 1 to 10 layers based on a single atomic layer in which carbon atoms are bonded in a hexagonal lattice shape (honeycomb structure). Graphene is one of the allotropes of carbon, and may have a structure in which carbon atoms come together to form a two-dimensional plane.

When a voltage is applied to the graphene, an electrical current may flow through the graphene, and heat may be generated due to the resistance that graphene has. Due to this characteristic, when a voltage is applied to the graphene scroll 200 and an electrical current flows, the graphene scroll 200 may generate heat due to the electrical current resistance.

The graphene has high electrical conductivity and thus when a voltage is applied, the power consumption rate is low but the heat generation efficiency is relatively high. Additionally, the graphene has high thermal conductivity and excellent heat transfer efficiency. Accordingly, the graphene scroll 200 may have high fluid heating efficiency.

Additionally, due to the characteristics of graphene, the graphene scroll 200 may be configured to rapidly heat water when a voltage is applied. Accordingly, a dispensed volume of hot water heated by the graphene scroll 200 may also increase. Conversely, the graphene scroll 200 may be configured to quickly return to an original temperature thereof when the voltage application is blocked.

As mentioned above, when using the graphene scroll 200 as a heat source of the heater 100, it is possible to easily control whether or not heat is generated according to whether a voltage is applied. In addition, even when the water is not heated, the temperature of the graphene scroll 200 may be easily lowered by cutting off the power, thereby preventing the heater 100 and a vicinity of the heater 100 from being damaged by high heat.

Additionally, the graphene has the characteristic of high physical strength, and thus the graphene scroll 200 may not be easily damaged by external impact.

In addition, in comparison with the type heated by an electrical current-flowing heat wire, when a voltage is applied to the graphene scroll 200, an electrical current may flow through the entire area of the graphene scroll 200 and heat may be generated in the entire area of the graphene scroll 200 due to the characteristics of graphene. Accordingly, even when a portion of the graphene scroll 200 is damaged, the remaining portion thereof may generate heat by applying a voltage.

Additionally, the graphene has the characteristic of having a very high surface area per particle unit, and thus it may be easier to manufacture a lightweight heater when using the graphene scroll 200.

The graphene scroll 200 may be provided to allow a fluid to pass through. Particularly, in the water purifier 1, the graphene scroll 200 may be provided to allow water to pass through. The graphene scroll 200 may form the heating flow path 103. The heating flow path 103 may be formed in an inner space of the graphene scroll 200.

Particularly, the graphene scroll 200 may include the inlet 101 described above. The inlet 101 may be formed to allow water to flow into the graphene scroll 200. The inlet 101 may be disposed on one side of the graphene scroll 200.

The graphene scroll 200 may include the outlet 102 described above. The outlet 102 may be formed to discharge water from the graphene scroll 200. The outlet 102 may be disposed on the other side of the graphene scroll 200 opposite to the inlet 101.

The heating flow path 103 may extend from the inlet 101 to the outlet 102.

The heating flow path 103 may extend in a direction corresponding to the direction in which the graphene scroll 200 extends. Additionally, a length in which the heating flow path 103 extends may correspond to a length in which the graphene scroll 200 extends.

The graphene scroll 200 may be composed of a planar heating element. The planar heating element may be not limited to a heating element having an overall planar shape, but may include the case in which even when a component has a curved shape, such as the graphene scroll 200 shown in FIG. 5, a portion of the component has a thin surface shape.

As the graphene scroll 200 is composed of a planar heating element as mentioned above, an area in which the graphene scroll 200 is in contact with the liquid may increase, and an overall heat generation area/heat transfer area of the graphene scroll 200 may increase. In other words, an area in which the graphene scroll 200 is in contact with the heating flow path 103 may increase. Accordingly, the liquid heating efficiency by the graphene scroll 200 may be improved.

The heating flow path 103 formed by the graphene scroll 200 may have a central axis (CA). The central axis (CA) of the heating flow path 103 may extend between the inlet 101 and the outlet 102. The central axis (CA) of the heating flow path 103 may be an axis that passes through the center of the heating flow path 103 and that passes through the inlet 101 and the outlet 102, and may mean a central axis extending in the direction in which the liquid flows along the heating flow path 103. The central axis of the heating flow path 103 may coincide with a central axis of the graphene scroll 200.

For example, as illustrated in FIG. 5, when the inlet 101 and the outlet 102 are arranged side by side in one direction, in other words, when a direction in which a liquid flows through the inlet 101, a direction in which a liquid flows along the heating flow path 103, and a direction in which a liquid is discharged through the outlet 102 are parallel to each other, the heating flow path 103 may have a shape extending in one direction, and the central axis (CA) of the heating flow path 103 may extend in the same direction. However, when the inlet 101 and the outlet 102 are not arranged side by side or the heating flow path 103 extending between the inlet 101 and the outlet 102 has a curved shape in at least some regions, the central axis (CA) of the heating flow path 103 may also have a curved shape at least in part.

The graphene scroll 200 may extend to allow a distance from the central axis (CA) to increase from one end adjacent to the central axis (CA) of the heating flow path 103 toward the other end. Particularly, the graphene scroll 200 may include a first end 201 parallel to the central axis (CA) of the heating flow path 103 and a second end 202 opposite the first end 201. The graphene scroll 200 may be provided to allow the distance from the central axis (CA) to increase as the graphene scroll 200 extends from the first end 201 toward the second end 202. The distance from the central axis (CA) may refer to the shortest distance between the central axis (CA) and a point of the graphene scroll 200 located between the first end 201 and the second end 202.

For example, the first end 201 of the graphene scroll 200 may be parallel to the central axis (CA) of the heating flow path 103. For example, the second end 202 of the graphene scroll 200 may be parallel to the central axis (CA) of the heating flow path 103.

The graphene scroll 200 may extend from the first end 201 toward the second end 202 in a first direction D1. The graphene scroll 200 may extend to allow the distance from the central axis (CA) to increase toward the first direction D1. The first direction D1 is counterclockwise with respect to FIG. 6, but is not limited thereto. Alternatively, the first direction D1 may be clockwise with respect to FIG. 6.

The graphene scroll 200 may extend to allow an angle, which is measured in the first direction D1 about the central axis (CA), to increase from the first end 201 to the second end 202.

A portion of the graphene scroll 200 may be covered in an outer direction by another portion. For example, another portion, which is in a position extending in the first direction D1 at 360 degrees or more from one portion of the graphene scroll 200, may cover the one portion in the outer direction. The outer direction may mean a direction adjacent to the outside of the graphene scroll 200 and a position farther from the central axis (CA) of the heating flow path 103.

For example, the graphene scroll 200 may be formed in a scroll shape formed by bending a flat graphene sheet 200s into a curved shape. The scroll shape of the graphene scroll 200 may mean a shape formed by winding the graphene sheet 200s in one direction about one axis. For example, the graphene scroll 200 may be formed by winding the graphene sheet 200s from one of the pair of short sides toward the other short side about an axis parallel to the pair of short sides of the graphene sheet 200s. Alternatively, the graphene scroll 200 may be formed by winding the graphene sheet 200s from one of the pair of long sides toward the other long side about an axis parallel to the pair of long sides of the graphene sheet 200s.

Alternatively, a length of all sides of the graphene sheet 200s may be the same, and in this case, the graphene scroll 200 may be formed by winding the graphene sheet 200s from one side toward one side opposite to the one side about an axis parallel to one side among the sides of the graphene sheet 200s.

Referring to FIG. 6, the graphene scroll 200 may include a first portion 211. The first portion 211 of the graphene scroll 200 may extend in the first direction D1 from one side adjacent to the central axis (CA) of the heating flow path 103 toward the other side. The first portion 211 of the graphene scroll 200 may extend to allow the distance from the central axis (CA) to increase toward the first direction D1.

Additionally, the graphene scroll 200 may include a second portion 212. The second portion 212 of the graphene scroll 200 may extend from the first portion 211 in the first direction D1. The second portion 212 of the graphene scroll 200 may extend in the first direction D1 from one side of the second portion 212 adjacent to the central axis (CA) to the other side. The second portion 212 of the graphene scroll 200 may extend to allow the distance from the central axis (CA) to increase toward the first direction D1.

At this time, the second portion 212 of the graphene scroll 200 may cover the first portion 211 from the outer direction.

Further, the graphene scroll 200 may further include a third portion 213 extending from the second portion 212 in the first direction D1 and covering the second portion 212 from the outer direction, a fourth portion 214 extending from the third portion 213 in the first direction D1 and covering the third portion 213 from the outer direction, a fifth portion 215 extending from the fourth portion 214 in the first direction D1 and covering the fourth portion 214 from the outer direction, and a sixth portion 216 extending from the fifth portion 215 in the first direction D1 and covering the fifth portion 215 from the outer direction. The third portion 213, the fourth portion 214, the fifth portion 215, and the sixth portion 216 of the graphene scroll 200 may extend to allow a distance from the central axis (CA) to increase toward the first direction D1.

With this structure, the graphene scroll 200 may have the shape of a scroll in which the graphene sheet 200s is wound about a single axis.

FIG. 6 illustrates an embodiment in which the graphene scroll 200 extends in the first direction D1 at 360 degrees by approximately six times, but the disclosure is not limited thereto. For example, unlike FIG. 6, the graphene scroll 200 may include only the first portion 211 and the second portion 212. Alternatively, unlike FIG. 6, the graphene scroll 200 may further include a portion extending from the sixth portion 216 in the first direction D1.

In addition, FIG. 6 illustrates an example in which each portion of the graphene scroll 200, such as the first portion 211 and the second portion 212, extends at approximately 360 degrees about the central axis (CA), but this is only an example, in which each portion of the graphene scroll 200 is divided, for convenience of description. Therefore, the disclosure is not limited by the angle at which each portion of the graphene scroll 200 extends.

One portion of the graphene scroll 200 may have a shape in which one surface of the one portion extends without being in contact with another portion that covers the one portion. In other words, one portion of the graphene scroll 200 and another portion covering the one portion may be spaced apart in a direction away from the central axis (CA). In other words, a space may be formed between one portion of the graphene scroll 200 and another portion covering the one portion, and a liquid may flow through the space. That is, at least a portion of the heating flow path 103 may be formed between one portion of the graphene scroll 200 and another portion covering the one portion of the graphene scroll 200.

Referring to FIG. 6, the second portion 212 of the graphene scroll 200 may be disposed at a position spaced apart from the first portion 211 in the direction away from the central axis (CA). At this time, at least a portion of the heating flow path 103 may be formed in the space between the first portion 211 and the second portion 212. Additionally, at least a portion of the heating flow path 103 may be formed in an inner space of the first portion 211 (that is, a space surrounded by the first portion 211 of the graphene scroll 200).

In the same manner as the above mention, the third portion 213 of the graphene scroll 200 may be disposed at a position spaced apart from the second portion 212 in the direction away from the central axis (CA), and at least a portion of the heating flow path 103 may be formed in a space between the second portion 212 and the third portion 213. In addition, the fourth portion 214 of the graphene scroll 200 may be disposed at a position spaced apart from the third portion 213 in the direction away from the central axis (CA), and at least a portion of the heating flow path 103 may be formed in a space between the third portion 213 and the fourth portion 214. In addition, the fifth portion 215 of the graphene scroll 200 may be disposed at a position spaced apart from the fourth portion 214 in the direction away from the central axis (CA), and at least a portion of the heating flow path 103 may be formed in a space between the fourth portion 214 and the fifth portion 215. In addition, the sixth portion 216 of the graphene scroll 200 may be disposed at a position spaced apart from the fifth portion 215 in the direction away from the central axis (CA), and at least a portion of the heating flow path 103 may be formed in a space between the fifth portion 215 and the sixth portion 216.

At this time, portions of the heating flow path 103 formed between each portion of the graphene scroll 200 may be connected to each other. In other words, a portion of the heating flow path 103 formed in the inner space of the first portion 211 of the graphene scroll 200, a portion of the heating flow path 103 formed between the first portion 211 and the second portion 212 of the graphene scroll 200, a portion of the heating flow path 103 formed between the second portion 212 and the third portion 213 of the graphene scroll 200, a portion of the heating flow path 103 formed between the third portion 213 and the fourth portion 214 of the graphene scroll 200, a portion of the heating flow path 103 formed between the fourth portion 214 and the fifth portion 215 of the graphene scroll 200, and a portion of the heating flow path 103 formed between the fifth portion 215 and the sixth portion 216 of the graphene scroll 200 may be connected to each other.

With the structure of the graphene scroll 200, an area, in which the graphene scroll 200 is in contact with the heating flow path 103, may be increased, and a heat generation area of the graphene scroll 200 to a volume occupied by the graphene scroll 200 may be increased. Accordingly, the graphene scroll 200 may heat the liquid more efficiently.

The graphene has high durability and flexibility due to the characteristics thereof, and thus it may be easy to manufacture the graphene scroll 200 with the structure described above using the planar graphene sheet 200s.

The graphene scroll 200 may be configured to heat the liquid that is introduced through the inlet 101 and flows along the heating flow path 103 toward the outlet 102. Accordingly, as the length of the heating flow path 103 between the inlet 101 and the outlet 102 is increased, it is easier to secure time to heat the liquid. Therefore, as illustrated in FIG. 5, the graphene scroll 200 may have the shape of a bar elongated between the inlet 101 and the outlet 102. For example, as illustrated in FIG. 5, the graphene scroll 200 may have the shape of a bar elongated in one direction between the inlet 101 and the outlet 102. Accordingly, the graphene scroll 200 may be referred to as a ‘graphene bar’.

As described above, the graphene scroll 200 may be configured to generate heat based on an applied voltage. The heater 100 may include the power supplier 40 configured to apply a voltage to the graphene scroll 200. For example, the power supplier 40 may be configured to apply alternating current power, but is not limited thereto. Alternatively, the power supplier 40 may be configured to apply direct current power. The power supplier 40 may be controlled by the controller 50 (refer to FIG. 4) to apply a voltage to the graphene scroll 200. The power supplier 40 may also be referred to as the ‘heater drive 40’.

For example, the power supplier 40 may be connected to an external power source and receive power from the external power source. Alternatively, the power supplier 40 may receive power by being connected to a battery that charges power.

For example, the power supplier 40 may include electronic components for applying a voltage to the graphene scroll 200, and a printed circuit board on which the electronic components are mounted.

The heater 100 may include the plurality of electrodes 300. The plurality of electrodes 300 may be configured to apply a voltage to the graphene scroll 200. The plurality of electrodes 300 may each be in contact with the graphene scroll 200 to apply a voltage to the graphene scroll 200.

Each of the plurality of electrodes 300 may be electrically connected to the power supplier 40. For example, each of the plurality of electrodes 300 may be electrically connected to the power supplier 40 through a wire. The plurality of electrodes 300 may each be connected to the power supplier 40, and the power supplier 40 may generate a potential difference between the plurality of electrodes 300 or remove the potential difference. The graphene scroll 200 may receive power from the power supplier 40 through the plurality of electrodes 300.

When a voltage is applied between the plurality of electrodes 300, an electric field may be generated in a region located between the plurality of electrodes 300 of the graphene scroll 200. As a result, an electrical current may flow in the region located between the plurality of electrodes 300 of the graphene scroll 200, and heat due to resistance may be generated in the region. Accordingly, the graphene scroll 200 may be configured to generate heat based on the applied voltage.

Referring to FIGS. 5 and 7, the plurality of electrodes 300 may include a pair of counter electrodes 310 and 320. The pair of counter electrodes 310 and 320 may be arranged to be spaced apart from each other. For example, one of the pair of counter electrodes 310 and 320 may be disposed adjacent to the first end 201 of the graphene scroll 200, and the other counter electrode 320 may be disposed adjacent to the second end 202 of the graphene scroll 200. In FIG. 5, it is illustrated that the pair of counter electrodes 310 and 320 is disposed at both ends of the graphene scroll 200, respectively. Alternatively, the pair of counter electrodes 310 and 320 may be disposed in a location spaced apart from both ends of the graphene scroll 200.

The pair of counter electrodes 310 and 320 may each be electrically connected to the power supplier 40. A circuit including the pair of counter electrodes 310 and 320 and the power supplier 40 may be configured in various ways and thus whether a voltage is applied or not between the pair of counter electrodes 310 and 320 may vary according to the operation of the power supplier 40.

The plurality of electrodes 300 may extend in directions parallel to each other. As each of the plurality of electrodes 300 extends in the directions parallel to each other, the amount of heat generated in a region between the plurality of electrodes 300 of the graphene scroll 200 may be maintained constant throughout.

For example, as illustrated in FIGS. 5 and 7, each of the plurality of electrodes 300 may extend in a direction parallel to the direction in which the heating flow path 103 extends. Particularly, each of the plurality of electrodes 300 may extend in a direction parallel to the direction in which the heating flow path 103 extends from the inlet 101 toward the outlet 102. Each of the plurality of electrodes 300 may extend in a direction substantially parallel to the central axis (CA) of the heating flow path 103.

For example, as illustrated in FIG. 5, the first side electrode 310 of the pair of counter electrodes 310 and 320 may extend along the first end 201 of the graphene scroll 200. The first side electrode 310 of the pair of counter electrodes 310 and 320 may be in contact with the first end 201 of the graphene scroll 200 and may be spaced apart from the second end 202.

For example, as illustrated in FIG. 5, the second side electrode 320 of the pair of counter electrodes 310 and 320 may extend along the second end 202 of the graphene scroll 200. The second side electrode 320 of the pair of counter electrodes 310 and 320 may be in contact with the second end 202 of the graphene scroll 200 and spaced apart from the first end 201.

For example, when the graphene sheet 200s has a rectangular shape as illustrated in FIG. 7, each of the pair of counter electrodes 310 and 320 may extend in a direction parallel to the short side of the graphene sheet 200s. In this case, the central axis (CA) of the heating flow path 103 may be parallel to the short side of the graphene sheet 200s. However, according to the shape of the graphene sheet 200s, the central axis (CA) of the heating flow path 103 may be parallel to the long side of the graphene sheet 200s, and in this case, the pair of counter electrodes 310 and 320 may extend in a direction parallel to the long side of the graphene sheet 200s. Alternatively, the graphene sheet 200s may have an approximately square shape.

The structure of the graphene sheet 200s forming the graphene scroll 200 will be described in more detail with reference to FIG. 7.

A of FIG. 7 illustrates an enlarged view of each layer by cutting the first side electrode 310 of the pair of counter electrodes 310 and 320 and a portion of the graphene sheet 200s in contact with the first side electrode 310. B of FIG. 7 illustrates an enlarged view of each layer by cutting the second side electrode 320 of the pair of counter electrodes 310 and 320 and a portion of the graphene sheet 200s in contact with the second side electrode 320. C of FIG. 7 illustrates an enlarged view of each layer by cutting a portion of the graphene sheet 200s located between the pair of counter electrodes 310 and 320.

A structure of A and a structure of B of FIG. 7 may correspond to each other.

Referring to A, B and C of FIG. 7, the graphene sheet 200s may include a graphene layer 200a in which graphene is arranged in at least one layer, and a base layer 200b supporting the graphene layer 200a. That is, the graphene scroll 200 may include the graphene layer 200a and the base layer 200b.

The graphene layer 200a may be configured to generate heat through resistance when a voltage is applied and an electrical current flows. At this time, a thickness of one layer of graphene may be approximately 0.2 nanometers, and a thickness of the graphene layer 200a provided on the graphene sheet 200s may be 10 micrometers or less. Because the graphene layer 200a is very thin, the graphene sheet 200s may require the base layer 200b to support the graphene layer 200a. For example, the base layer 200b may have a thickness of approximately 50 micrometers. The base layer 200b may be formed in the shape of a thin film to allow the graphene layer 200b to be attached thereon so as to support the graphene layer 200b.

The graphene layer 200a may be coupled to one surface of the base layer 200b. For example, the graphene layer 200a and the base layer 200b may be coupled to each other by intermolecular forces (van der Waals force, etc.).

Because the graphene layer 200a is a portion that generates heat when a voltage is applied, the base layer 200b may be formed of a material with high heat resistance. For example, the base layer 200b may be formed of a material containing polyamide, but is not limited thereto. Alternatively, the base layer 200b may be formed of various materials such as a resin material containing polyethylene terephthalate (PET).

Due to the flexible nature of graphene, the graphene layer 200a may have high flexibility. Additionally, the base layer 200b may be provided to be highly flexible. For example, the base layer 200b may be formed of a film formed of a material containing the above-described polyimide, polyethylene terephthalate, etc. Accordingly, it may be easy to bend the graphene layer 200a and the base layer 200b.

Referring to A and B of FIG. 7, the plurality of electrodes 300 may each be coupled to the graphene sheet 200s. Particularly, the plurality of electrodes 300 may each be attached to the graphene layer 200a. The plurality of electrodes 300 may be attached to one surface of the graphene layer 200a that is opposite to the other surface of the graphene layer 200a coupled to the base layer 200b. Accordingly, each of the plurality of electrodes 300 may be electrically connected to the graphene layer 200a, and when a voltage is applied between the plurality of electrodes 300, an electrical current may flow in the graphene layer 200a.

Referring to A and B of FIG. 7, each of the plurality of electrodes 300 may be coupled to the graphene sheet 200s by an adhesive layer (ad). Each of the plurality of electrodes 300 may be attached to the graphene layer 200a by the adhesive layer (ad). The adhesive layer (ad) may be arranged between the graphene layer 200a and the electrode 300. The adhesive layer (ad) may be provided to have high electrical conductivity so as to electrically connect each of the plurality of electrodes 300 to the graphene layer 200a.

For example, the adhesive layer (ad) may include various types of conductive adhesives such as silver paste.

For example, the adhesive layer (ad) may have a thickness of approximately 10 micrometers or less.

However, the disclosure is not limited thereto, and each of the plurality of electrodes 300 may be coupled to the graphene layer 200a in various ways.

For example, referring to A and B of FIG. 7, each of the plurality of electrodes 300 may include a contact electrode 300a. The contact electrode 300a may be in contact with the graphene sheet 200s and electrically connected to the graphene sheet 200s. Particularly, the contact electrode 300a may be attached to one surface, which is opposite to one surface coupled to the base layer 200b, between both surfaces of the graphene layer 200a. The contact electrode 300a may be electrically connected to the power supplier 40. The graphene layer 200a may receive a voltage through the plurality of contact electrodes 300a.

The contact electrode 300a may include a conductive material. For example, the contact electrode 300a may include various types of conductive metal materials such as copper.

For example, the contact electrode 300a may have a thickness of approximately 60 micrometers.

For example, the above-described adhesive layer (ad) may be disposed between the contact electrode 300a and the graphene layer 200a. The contact electrode 300a may be attached to the graphene layer 200a by the adhesive layer (ad). The contact electrode 300a may be electrically connected to the graphene layer 200a through the adhesive layer (ad).

For example, referring to A and B of FIG. 7, each of the plurality of electrodes 300 may include a pad electrode 300b. The pad electrode 300b may be electrically connected to the contact electrode 300a. The pad electrode 300b may be coupled to the contact electrode 300a. The pad electrode 300b may be attached to the other surface of the contact electrode 300a that is opposite to one surface of the contact electrode 300a facing the graphene layer 200a. The pad electrode 300b may be electrically connected to the power supplier 40.

The pad electrode 300b may include a conductive material. For example, the pad electrode 300b may be formed by soldering various types of conductive metals such as solder.

For example, the contact electrode 300a and the pad electrode 300b may be coupled to each other using a conductive adhesive such as silver paste. However, the disclosure is not limited thereto, and the contact electrode 300a and the pad electrode 300b may be coupled to each other in various ways.

For example, a wire connecting each of the plurality of electrodes 300 to the power supplier 40 may be connected to the pad electrode 300b and/or the contact electrode 300a. Accordingly, the plurality of electrodes 300 may be electrically connected to the power supplier 40, and the graphene layer 200a may receive a voltage through the plurality of electrodes 300.

Referring to A, B and C of FIG. 7, the graphene sheet 200s may further include an encapsulation layer (en). That is, the graphene scroll 200 may include an encapsulation layer (en). The encapsulation layer (en) may be provided to protect the graphene layer 200a from the outside. The encapsulation layer (en) may be disposed on one side, which is opposite to the base layer 200b, of the graphene layer 200a. The encapsulation layer (en) may be formed through an encapsulation process that surrounds one side, which is opposite to the base layer 200b, of the graphene layer 200a. The encapsulation layer (en) may form one outer surface of the graphene scroll 200.

Referring to A and B of FIG. 7, the encapsulation layer (en) may cover the plurality of electrodes 300, respectively. Particularly, the encapsulation layer (en) may cover the pad electrode 300b of each of the plurality of electrodes 300.

Referring to C of FIG. 7, the encapsulation layer (en) may cover the graphene layer 200a.

In other words, the encapsulation layer (en) may entirely cover one side of the graphene layer 200a and form one surface of the graphene sheet 200s. The plurality of electrodes 300 may be disposed between a portion of the encapsulation layer (en) and a portion of the graphene layer 200a.

The encapsulation layer (en) may be composed of a highly flexible material. The encapsulation layer (en) may be composed of a material with high moisture resistance or heat resistance. For example, the encapsulation layer (en) may include various materials such as resin materials such as epoxy and polyethylene terephthalate (PET).

The encapsulation layer (en) may be composed of an insulating material.

For example, the encapsulation layer (en) may be formed in the form of a flexible and thin film.

For example, the encapsulation layer (en) may have a thickness of approximately 50 micrometers.

For example, when the graphene sheet 200s is wound to form the graphene scroll 200, the encapsulation layer (en) may be arranged to face the outer direction of the graphene scroll 200 (i.e., direction away from the central axis (CA) of the heating flow path 103), and the base layer 200b may be arranged to face an inner direction of the graphene scroll 200 (i.e., direction closer to the central axis (CA) of the heating flow path 103).

In contrast, when the graphene sheet 200s is wound to form the graphene scroll 200, the base layer 200b may be arranged to face the outer direction of the graphene scroll 200 (i.e., direction away from the central axis (CA) of the heating flow path 103), and the encapsulation layer (en) may be arranged to face the inner direction of the graphene scroll 200 (i.e., direction closer to the central axis (CA) of the heating flow path 103).

The structure of each layer forming the graphene sheet 200s and the plurality of electrodes 300 is not limited to the above-mentioned example. In addition, the thickness and material of each of the above layers forming the graphene sheet 200s, the plurality of electrodes 300, etc. are not limited to those described above.

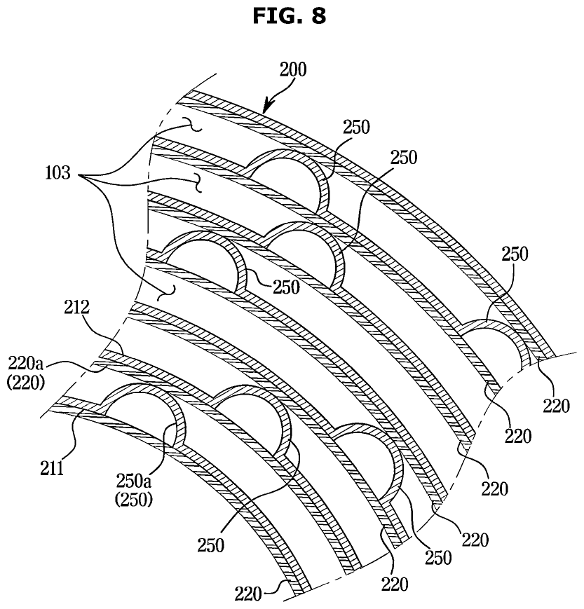

FIG. 8 is an enlarged view of a portion of the graphene scroll of the water purifier according to an embodiment of the disclosure.

Referring to FIG. 8, the heater 100 according to an embodiment of the disclosure may further include a spacer 250. The spacer 250 may be provided to maintain a separation space between one portion of the graphene scroll 200 and another portion covering the one portion from the outer direction. The spacer 250 may be provided to support one portion of the graphene scroll 200 or another portion covering the one portion from the outer direction. The spacer 250 may be disposed within the heating flow path 103.

Due to the flexible nature of graphene, it is easy to manufacture curved shapes such as the graphene scroll 200. However, due to this flexibility, a structure that maintains the shape may be required. The spacer 250 may prevent an internal space of the graphene scroll 200 from being deformed caused by the flexibility of graphene.

For example, the spacer 250 may protrude from one portion of the graphene scroll 200 toward the outer direction (i.e., direction away from the central axis (CA) of the heating flow path 103) to support another portion that covers the one portion of the graphene scroll 200 from the outer direction.

For example, as illustrated in FIG. 8, the spacer 250 may be formed integrally with the graphene scroll 200. Particularly, the spacer 250 may be formed by bending a portion of the graphene scroll 200. A portion of the bent graphene scroll 200 may include a portion of the graphene layer 200a and a portion of the base layer 200b. Alternatively, the spacer 250 may be formed as a separate configuration from the graphene scroll 200 and may be coupled to the graphene scroll 200.

For example, as illustrated in FIG. 8, a plurality of spacers 250 may be provided. The plurality of spacers 250 may be arranged to be spaced apart from each other within the heating flow path 103.

The graphene scroll 200 may further include a support layer 220. The support layer 220 may form one outer surface of the graphene scroll 200. Particularly, the support layer 220 may be disposed on one surface of the graphene scroll 200 supported by the spacer 250. The spacer 250 may protrude from one portion of the graphene scroll 200, and the support layer 220 may be provided on another portion that covers the one portion of the graphene scroll 200. Accordingly, as the spacer 250 is in contact with the support layer 220, the spacer 250 may support the another portion of the graphene scroll 200.

For example, the support layer 220 may be attached to one surface of the base layer 200b opposite to the graphene layer 200a. That is, the support layer 220 may be provided on one surface, which is opposite to the encapsulation layer (en), of the graphene scroll 200. For example, the support layer 220 may form one inner surface of the graphene scroll 200 (that is, one surface facing the central axis (CA) of the heating flow path 103).

The support layer 220 may be formed in a thin film shape.

For example, the support layer 220 may be formed of various materials, such as a resin material containing polyethylene terephthalate (PET) material.

As mentioned above, as the spacer 250 comes into contact with the support layer 220, the spacer 250 may support more stably other portion of the graphene scroll 200.

When describing the spacer 250 based on one spacer 250a among the plurality of spacers 250 shown in FIG. 8, the spacer 250a may be provided to form a separation space between the first portion 211 and the second portion 212 of the graphene scroll 200. For example, the spacer 250a may protrude from the first portion 211 of the graphene scroll 200 toward the second portion 212. In other words, the spacer 250a may protrude from the first portion 211 of the graphene scroll 200 toward the direction away from the central axis (CA) of the heating flow path 103. As a result, the spacer 250a may support the second portion 212 of the graphene scroll 200 and maintain the separation space between the first portion 211 and the second portion 212 of the graphene scroll 200.

A portion 220a of the support layer 220 may be arranged on one surface facing the first portion 211 of the second portion 212 of the graphene scroll 200. At this time, the spacer 250a may protrude from the first portion 211 and be in contact with the support layer 220, thereby supporting the second portion 212.

Each spacer 250 disposed in the graphene scroll 200 may have characteristics corresponding to the spacer 250a described above.

Unlike FIG. 8, the graphene scroll 200 may not include a separate support layer 220, and in this case, the spacer 250 may be in direct contact with the base layer 200b of another portion of the graphene scroll 200.

Unlike FIG. 8, the spacer 250 may be disposed on one side of the graphene scroll 200 and may be formed as a configuration separated from the graphene scroll 200. For example, the spacer 250 may be disposed on one side of the encapsulation layer (en) of one portion of the graphene scroll 200 and may be formed in a shape that protrudes toward another portion covering the one portion. In this way, the spacer 250 formed on one side of the encapsulation layer (en) may include a material with high heat resistance. For example, the spacer 250 may be formed of various materials such as polyethylene terephthalate (PET).

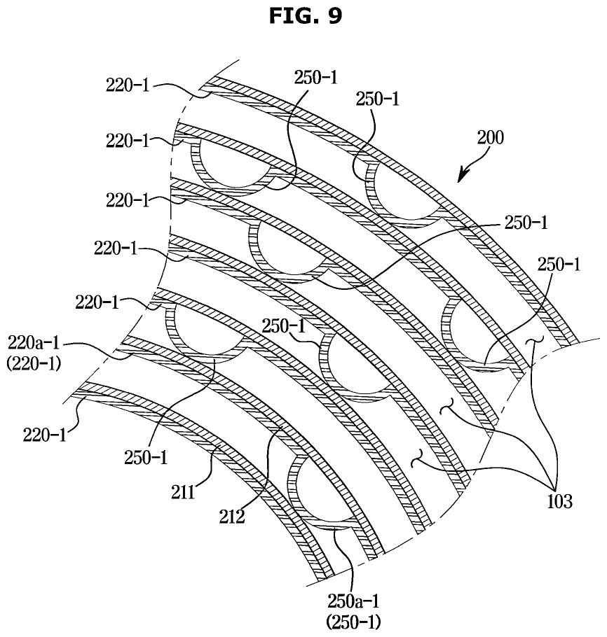

FIG. 9 is an enlarged view of a portion of a graphene scroll of the water purifier according to an embodiment of the disclosure.

Referring to FIG. 9, the heater 100 according to an embodiment of the disclosure may further include a spacer 250-1. Similar to the spacer 250 of FIG. 8, the spacer 250-1 of FIG. 9 may be provided to form a separation space between one portion of the graphene scroll 200 and another portion covering the one portion from the outward direction. The spacer 250-1 may be provided to support one portion of the graphene scroll 200 or another portion covering the one portion from the outer direction. The spacer 250-1 may be disposed within the heating flow path 103.

For example, the spacer 250-1 may protrude from one portion of the graphene scroll 200 toward the inner direction (i.e., direction towards the central axis (CA) of the heating flow path 103) so as to support another portion in which an outer side thereof is covered by the one portion of the graphene scroll 200.

For example, the graphene scroll 200 may include a support layer 220-1. Because the support layer 220-1 in FIG. 9 has characteristics corresponding to the support layer 220-1 in FIG. 8, a detailed description thereof is omitted.

At this time, the spacer 250-1 may protrude from the support layer 220-1. Particularly, the spacer 250-1 may protrude from one portion of the support layer 220-1, which is provided on one portion of the graphene scroll 200, and be in contact with another portion of the graphene scroll 200.

For example, as illustrated in FIG. 9, the spacer 250-1 may be formed integrally with the graphene scroll 200. Particularly, the spacer 250-1 may be formed by bending a portion of the graphene scroll 200. As illustrated in FIG. 9, the spacer 250-1 may be formed integrally with the support layer 220-1 of the graphene scroll 200. The spacer 250-1 may be formed by bending a portion of the support layer 220-1.

The spacer 250-1 may be manufactured by bending the support layer 220-1 that is provided separately from the graphene layer 200a and the base layer 200b. Accordingly, it is possible to select the material of the support layer 220-1 from various materials that are easier to bend than the graphene layer 200a and the base layer 200b that the material is specified to some extent. Therefore, it is possible to more efficiently manufacture the spacer 250-1.

Unlike FIG. 9, the spacer 250-1 may include a portion of the graphene layer 200a, a portion of the base layer 200b, etc.

Alternatively, the spacer 250-1 may be formed as a configuration separated from the graphene scroll 200 and may be coupled to the graphene scroll 200.

For example, as illustrated in FIG. 9, a plurality of spacers 250-1 may be provided. The plurality of spacers 250-1 may be arranged to be spaced apart from each other within the heating flow path 103.

When describing the spacer 250-1 based on one spacer 250a-1 among the plurality of spacers 250-1 shown in FIG. 9, the spacer 250a-1 may be provided to form a separation space between the first portion 211 and the second portion 212 of the graphene scroll 200. For example, the spacer 250a-1 may protrude from a portion 220a-1 of the support layer 220-1 provided in the second portion 212 of the graphene scroll 200 toward the first portion 211. In other words, the spacer 250a-1 may protrude from the portion 220a-1 of the support layer 220-1 provided in the second portion 212 of the graphene scroll 200 in the direction toward the central axis (CA) of the heating flow path 103. As a result, the spacer 250a-1 may support the first portion 211 of the graphene scroll 200 and maintain the separation space between the first portion 211 and the second portion 212 of the graphene scroll 200.

Each spacer 250-1 disposed in the graphene scroll 200 may have characteristics corresponding to the spacer 250a-1 described above.

Unlike FIG. 9, the graphene scroll 200 may not include a separate support layer 220-1, and in this case, the spacer 250-1 may be not formed by the support layer 220-1, but formed by directly bending a portion of the graphene layer 200a, a portion of the base layer 200b, etc. Alternatively, the spacer 250-1 may be formed as a separate configuration and attached to one surface of the base layer 200b (i.e., one surface of the base layer 200b opposite to the graphene layer 200a that is one inner surface).

With the configuration according to the embodiment of FIG. 8 or the embodiment of FIG. 9, the shape of the graphene scroll 200 may be prevented from being deformed, and the heating flow path 103 formed between each portion of the graphene scroll 200 may be maintained efficiently. Accordingly, an area in which the graphene scroll 200 is in contact with the heating flow path 103 may be increased, and the liquid heating efficiency may be improved.

Unlike FIGS. 8 and 9, the graphene scroll 200 may not include a separate physical structure, such as the spacer 250 (or 250-1), configured to prevent the deformation of the shape of the graphene scroll 200. For example, when the material of the adhesive layer (ad) or the encapsulation layer (en) included in the graphene scroll 200 is a material that hardens after a certain period of time (or when a certain process is performed) after coating, the graphene scroll 200 may maintain the shape thereof after the manufacturing of the graphene scroll 200 is completed.

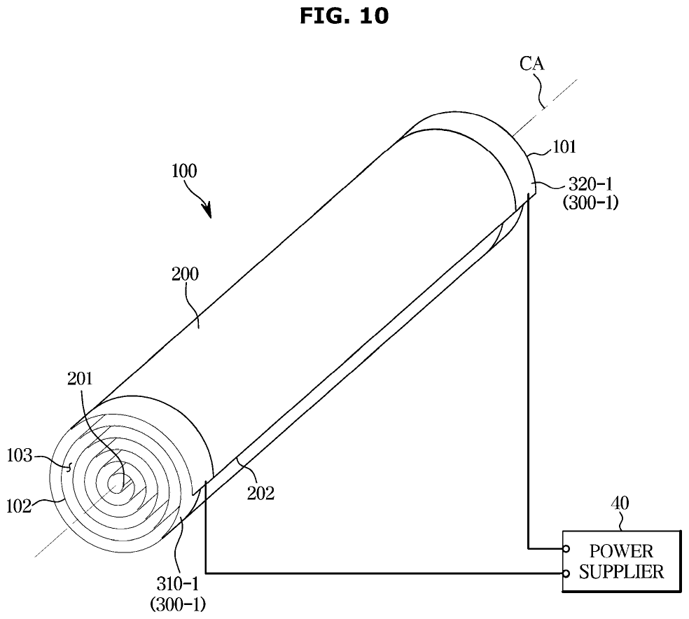

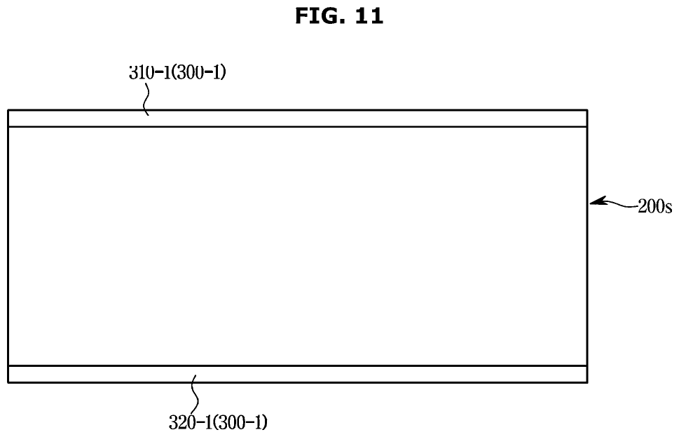

FIG. 10 illustrates a heater included in the water purifier according to an embodiment of the disclosure. FIG. 11 illustrates a graphene sheet forming a graphene scroll of FIG. 10 and electrodes connected to the graphene sheet according to an embodiment of the disclosure.

When describing an embodiment of the disclosure with reference to FIGS. 10 and 11, the same components as the embodiments of FIGS. 1 to 9 may have the same reference numerals and descriptions thereof may be omitted.

Referring to FIGS. 10 and 11, a heater 100 included in the water purifier 1 according to an embodiment of the disclosure may include a plurality of electrodes 300-1 configured to apply a voltage to the graphene scroll 200. The plurality of electrodes 300-1 may be in contact with the graphene scroll 200 and electrically connected to the graphene scroll 200. The plurality of electrodes 300-1 may be electrically connected to the power supplier 40. The plurality of electrodes 300-1 may be arranged to be spaced apart from each other. The power supplier 40 may be configured to apply a voltage between the plurality of electrodes 300-1.

Some of the plurality of electrodes 300-1 may be disposed adjacent to the inlet 101. Others of the plurality of electrodes 300-1 may be disposed adjacent to the outlet 102.

Particularly, the plurality of electrodes 300-1 may include a pair of counter electrodes 310-1 and 320-1. The pair of counter electrodes 310-1 and 320-1 may be arranged opposite to each other. A first side electrode 310-1 of the pair of counter electrodes 310-1 and 320-1 may be disposed adjacent to the outlet 102, and a second side electrode 320-1 of the pair of counter electrodes 310-1 and 320-1 opposite to the first side electrode 310-1 may be disposed adjacent to the inlet 101. The first side electrode 310-1 may be disposed to be spaced apart from the inlet 101, and the second side electrode 320-1 may be disposed to be spaced apart from the outlet 102.

A direction in which each of the plurality of electrodes 300-1 extends may be different from the direction in which the central axis (CA) of the heating flow path 103 extends. The plurality of electrodes 300-1 may be arranged in parallel with each other in the direction in which the inlet 101 and the outlet 102 face each other. The plurality of electrodes 300-1 may be arranged in parallel with each other in the direction in which the central axis (CA) of the heating flow path 103 extends.

Each of plurality of electrodes 300-1 may extend in a direction parallel to the direction extending from one end, which is adjacent to the central axis (CA) of the heating flow path 103, of the graphene scroll 200 toward the other end. In other words, each of the plurality of electrodes 300-1 may extend in a direction parallel to the direction in which the graphene scroll 200 extends from the first end 201 to the second end 202. That is, each of the plurality of electrodes 300-1 may extend in a first direction D1 from one end, which is adjacent to the central axis (CA) of the heating flow path 103, of both ends toward the other end. Each of the plurality of electrodes 300-1 may extend to allow a distance from the central axis (CA) of the heating flow path 103 to increase toward the first direction D1. Each of the plurality of electrodes 300-1 may be formed in a substantially scroll shape.

For example, as illustrated in FIG. 10, the first side electrode 310-1 of the pair of counter electrodes 310-1 and 320-1 may be disposed at one end, which is toward the outlet 102, of the graphene scroll 200. The second side electrode 320-1 of the pair of counter electrodes 310-1 and 320-1 may be disposed at the other end, which is toward the inlet 101, of the graphene scroll 200.

For example, when the graphene sheet 200s has a rectangular shape as illustrated in FIG. 11, each of the pair of counter electrodes 310-1 and 320-1 may extend parallel to the long side of the graphene sheet 200s. In this case, the central axis (CA) of the heating flow path 103 may be parallel to the short side of the graphene sheet 200s.

As illustrated in FIG. 11, each of the pair of counter electrodes 310 and 320 may extend in a direction parallel to the long side of the graphene sheet 200s, and the pair of counter electrodes 310 and 320 may opposite to each other with respect to the short side of the graphene sheet 200s. Further, the pair of counter electrodes 310 and 320 may be arranged at both ends of the graphene sheet 200s. When the pair of counter electrodes 310-1 and 320-1 extend in the direction parallel to the long side of the graphene sheet 200s in comparison with the case in which the pair of counter electrodes 310-1 and 320-1 extend in the direction parallel to the short side of the graphene sheet 200s, a distance between the pair of counter electrodes 310-1 and 320-1 may be reduced. When the distance between the pair of counter electrodes 310-1 and 320-1 is reduced, an intensity of electrical current flowing through the graphene scroll 200 may increase, which causes the increase in the amount of heat generation.

However, according to the shape of the graphene sheet 200s, the central axis (CA) of the heating flow path 103 may be parallel to the short side of the graphene sheet 200s, and in this case, the pair of counter electrodes 310-1 and 320-1 may extend in a direction parallel to the short side of the graphene sheet 200s. Alternatively, the graphene sheet 200s may have an approximately square shape.

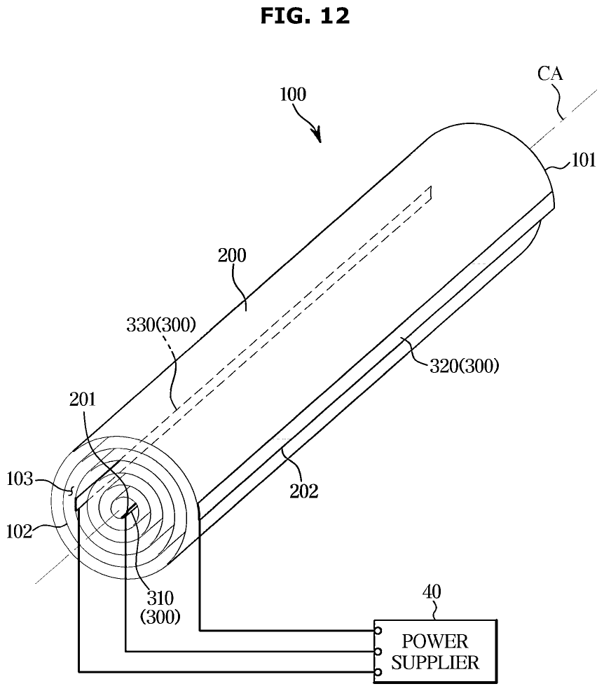

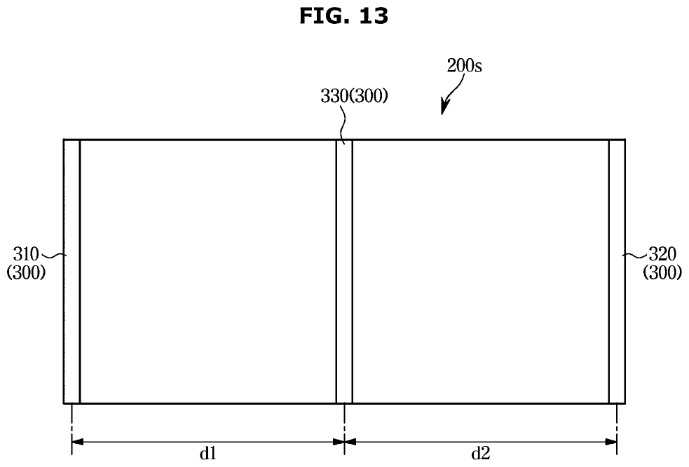

FIG. 12 illustrates a heater included in the water purifier and including three electrodes according to an embodiment of the disclosure. FIG. 13 illustrates a graphene sheet forming a graphene scroll of FIG. 12 and electrodes connected to the graphene sheet according to an embodiment of the disclosure.

When describing an embodiment of the disclosure with reference to FIGS. 12 and 13, the same components as the embodiments of FIGS. 1 to 9 may have the same reference numerals and descriptions thereof may be omitted.

Referring to FIGS. 12 and 13, a heater 100 included in the water purifier 1 according to an embodiment of the disclosure may include a pair of counter electrodes 310 and 320, and an intermediate electrode 330 disposed between the pair of counter electrodes 310 and 320. In other words, the plurality of electrodes 300 may further include the intermediate electrode 330 provided between the first side electrode 310 and the second side electrode 320 as well as the first side electrode 310 and the second side electrode 320. The first side electrode 310, the second side electrode 320, and the intermediate electrode 330 may each be electrically connected to the graphene scroll 200.

The intermediate electrode 330 may be arranged in parallel with each of the first side electrode 310 and the second side electrode 320. The intermediate electrode 330 may extend in a direction parallel to each of the first side electrode 310 and the second side electrode 320. For example, the intermediate electrode 330 may extend in a direction parallel to the direction in which the central axis (CA) of the heating flow path 103 extends. As illustrated in FIG. 12, the intermediate electrode 330 may extend between the inlet 101 and the outlet 102.

The intermediate electrode 330 may be electrically connected to the power supplier 40. Accordingly, a voltage may be applied between the first side electrode 310 and the second side electrode 320 by the power supplier 40. Further, a voltage may be applied between the first side electrode 310 and the intermediate electrode 330 by the power supplier 40. Further, a voltage may be applied between the second side electrode 320 and the intermediate electrode 330 by the power supplier 40. That is, the power supplier 40 may apply a voltage between the first side electrode 310 and the second side electrode 320, or apply a voltage between the first side electrode 310 and the intermediate electrode 330, or apply a voltage between the second side electrode 320 and the intermediate electrode 330.

The pair of counter electrodes 310 and 320 may be referred to as a “main electrode”, and the intermediate electrode 330 may be referred to as a “sub-electrode”.

A circuit including the pair of counter electrodes 310 and 320, the intermediate electrode 330 and the power supplier 40 may be configured in various ways and thus whether a voltage is applied or not between the pair of counter electrodes 310 and 320 may vary according to the operation of the power supplier 40.

For example, the pair of counter electrodes 310 and 320 and the intermediate electrode 330 may be connected to a single power supplier 40. By selectively controlling the on/off of a switch of the circuit including the pair of counter electrodes 310 and 320, the intermediate electrode 330, and the power supplier 40, the controller 50 may allow a voltage to be applied between the first side electrode 310 and the second side electrode 320, or to be applied between the first side electrode 310 and the intermediate electrode 330, or to be applied between the second side electrode 320 and the intermediate electrode 330.

Alternatively, the power supplier 40 may be composed of a plurality of separate modules. For example, the power supplier 40 may be composed of a power supplier configured to apply a voltage between the first side electrode 310 and the second side electrode 320, a power supplier configured to apply a voltage between the first side electrode 310 and the intermediate electrode 330, and a power supplier configured to apply a voltage between the second side electrode 320 and the intermediate electrode 330. The controller 50 may be configured to individually control each power supplier.

When a voltage is applied between the pair of counter electrodes 310 and 320 in comparison with the case in which a voltage is applied between one of the pair of counter electrodes 310 and 320 and the intermediate electrode 330, the heat generation area of the graphene scroll 200 may be increased and thus the liquid heating performance may be improved.

Accordingly, the at least one power supplier 40 may apply a voltage between either the first side electrode 310 or the second side electrode 320 and the intermediate electrode 330 based on a first condition. In other words, based on the first condition, the controller 50 may control the at least one power supplier 40 to allow a voltage to be applied between either the first side electrode 310 or the second side electrode 320 and the intermediate electrode 330. Further, the at least one power supplier 40 may apply a voltage between the first side electrode 310 and the second side electrode 320 based on a second condition. In other words, based on the second condition, the controller 50 may control the at least one power supplier 40 to allow a voltage to be applied between the pair of counter electrodes 310 and 320.

The first condition may be a condition for a target temperature of a provided liquid to be relatively low, and the second condition may be a condition for a target temperature of a provided liquid to be relatively high. In other words, when a condition for heating a liquid at a first temperature is referred to as the first condition, a condition for heating a liquid at a second temperature higher than the first temperature may be referred to as the second condition.

For example, the first condition and the second condition may be satisfied based on a user input being obtained through the input device 31 or the dispensing lever 530, respectively. That is, the controller 50 may control the at least one power supplier 40 to allow a voltage to be applied between either the first side electrode 310 or the second side electrode 320 and the intermediate electrode 330 based on obtaining a user input, which is for heating the liquid at the first temperature, through the input device 31 or the dispensing lever 530. The controller 50 may control the at least one power supplier 40 to allow a voltage to be applied between the pair of counter electrodes 310 and 320 based on obtaining a user input, which is for heating the liquid at the second temperature higher than the first temperature, through the input device 31 or the dispensing lever 530.

For example, the graphene scroll 200 may have an overall uniform configuration and heat generation density may be constant. A distance d1 between the first side electrode 310 and the intermediate electrode 330 and a distance d2 between the second side electrode 320 and the intermediate electrode 330 may be approximately the same. Heat generation density may refer to an amount of heat generation per unit heat generation area, which may vary according to factors such as the composition, material, and thickness of the graphene scroll 200. In this case, the amount of heat generation when a voltage is applied between the first side electrode 310 and the intermediate electrode 330 and the amount of heat generation when a voltage is applied between the second side electrode 320 and the intermediate electrode 330 may be approximately the same.

In contrast, the graphene scroll 200 may not have an overall uniform configuration, or the distance d1 between the first side electrode 310 and the intermediate electrode 330 and the distance d2 between the second side electrode 320 and the intermediate electrode 330 may be different. At this time, the amount of heat generation when a voltage is applied between the first side electrode 310 and the intermediate electrode 330 and the amount of heat generation when a voltage is applied between the second side electrode 320 and the intermediate electrode 330 may be different from each other.

For example, it may be assumed that the heat generation density of a portion of the graphene scroll 200 between the first side electrode 310 and the intermediate electrode 330 is less than the heat generation density of another portion between the second side electrode 320 and the intermediate electrode 330 or it may be assumed that the distance d1 between the first side electrode 310 and the intermediate electrode 330 is less than the distance d2 between the second side electrode 320 and the intermediate electrode 330. In this case, the amount of heat generation when a voltage is applied between the first side electrode 310 and the intermediate electrode 330 may be less than the amount of heat generation when a voltage is applied between the second side electrode 320 and the intermediate electrode 330.

In this case, the at least one power supplier 40 may apply a voltage between the first side electrode 310 and the intermediate electrode 330 based on a first condition, apply a voltage between the second side electrode 320 and the intermediate electrode 330 based on a second condition, and apply a voltage between the first side electrode 310 and the second side electrode 320 based on a third condition. In other words, the controller 50 may be configured to control the at least one power supplier 40 to apply a voltage between the first side electrode 310 and the intermediate electrode 330 based on the first condition, control the at least one power supplier 40 to apply a voltage between the second side electrode 320 and the intermediate electrode 330 based on the second condition, and control the at least one power supplier 40 to apply a voltage between the first side electrode 310 and the second side electrode 320 based on the third condition.

A condition for heating a liquid at a first temperature may be the first condition, a condition for heating a liquid at a second temperature higher than the first temperature may be the second condition, and a condition for heating a liquid at a third temperature higher than the second temperature may be the third condition.

With this configuration, the heater 100 may be configured to heat a liquid at various levels of temperature.

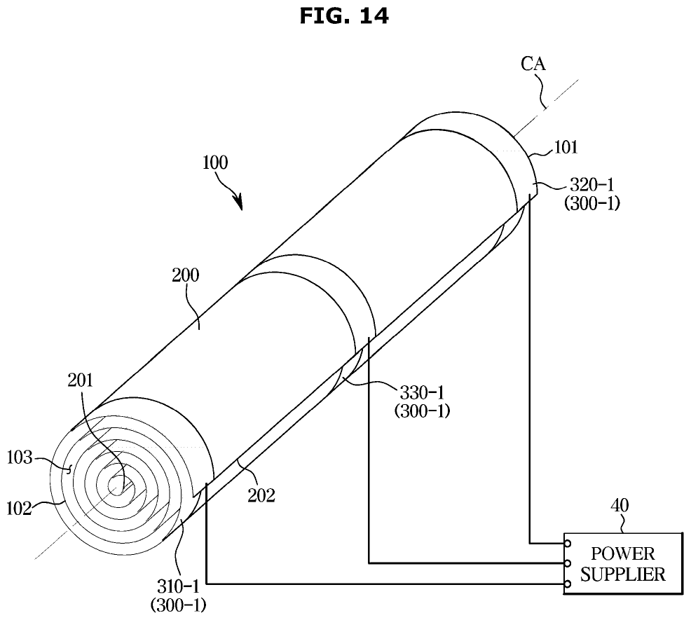

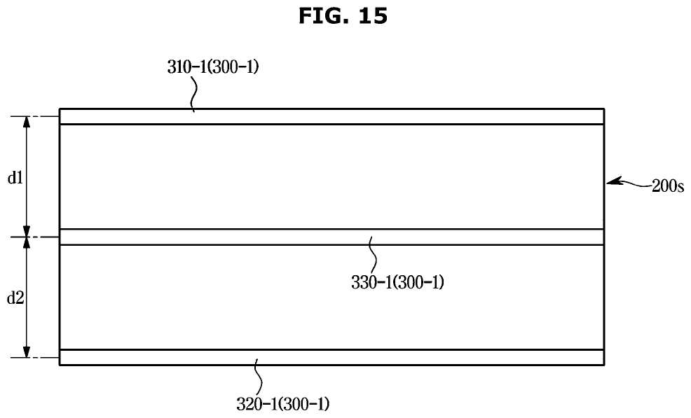

FIG. 14 illustrates a heater included in the water purifier and including three electrodes according to an embodiment of the disclosure. FIG. 15 illustrates a graphene sheet forming a graphene scroll of FIG. 14 and electrodes connected to the graphene sheet according to an embodiment of the disclosure.

When describing an embodiment of the disclosure with reference to FIGS. 14 and 15, the same components as the embodiments of FIGS. 10 and 11 may have the same reference numerals and descriptions thereof may be omitted.

Referring to FIGS. 14 and 15, a heater 100 included in the water purifier 1 according to an embodiment of the disclosure may include a pair of counter electrodes 310-1 and 320-1 and an intermediate electrode 330-1 disposed between the pair of counter electrodes 310-1 and 320-1. In other words, the plurality of electrodes 300-1 may further include the intermediate electrode 330-1 provided between the first side electrode 310-1 and the second side electrode 320-1 as well as the first side electrode 310-1 and the second side electrode 320-1. The first side electrode 310-1, the second side electrode 320-1, and the intermediate electrode 330-1 may each be electrically connected to the graphene scroll 200.

The intermediate electrode 330 may be arranged in parallel with each of the first side electrode 310-1 and the second side electrode 320-1. The intermediate electrode 330-1 may extend in a direction parallel to each of the first side electrode 310-1 and the second side electrode 320-1. For example, the direction in which the intermediate electrode 330-1 extends may be different from the direction in which the central axis (CA) of the heating flow path 103 extends. The intermediate electrode 330-1 may extend in a direction parallel to the direction extending from one end of the graphene scroll 200 adjacent to the central axis (CA) of the heating flow path 103 toward the other end. The intermediate electrode 330-1 may extend in a first direction D1 from one end, which is adjacent to the central axis (CA) of the heating flow path 103, of both ends toward the other end. The intermediate electrode 330-1 may extend to allow a distance from the central axis (CA) of the heating flow path 103 to increase toward the first direction D1. The intermediate electrode 330-1 may be formed in a substantially scroll shape.

The first side electrode 310-1, the intermediate electrode 330-1, and the second side electrode 320-1 may be arranged in parallel with the direction in which the inlet 101 and the outlet 102 face each other. The first side electrode 310-1, the intermediate electrode 330-1, and the second side electrode 320-1 may be arranged in parallel with each other in the direction in which the central axis (CA) of the heating flow path 103 extends.

As illustrated in FIG. 12, the intermediate electrode 330 may be arranged to be spaced apart from each of the inlet 101 and the outlet 102. The intermediate electrode 330 may be disposed between the inlet 101 and the outlet 102.

The intermediate electrode 330-1 may be electrically connected to the power supplier 40. Accordingly, a voltage may be applied between the first side electrode 310-1 and the second side electrode 320-1 by the power supplier 40. Further, a voltage may be applied between the first side electrode 310-1 and the intermediate electrode 330-1 by the power supplier 40. Further, a voltage may be applied between the second side electrode 320-1 and the intermediate electrode 330-1 by the power supplier 40. That is, the power supplier 40 may be configured to apply a voltage between the first side electrode 310-1 and the second side electrode 320-1, or between the first side electrode 310-1 and the intermediate electrode 330-1, or between the second side electrode 320-1 and the intermediate electrode 330-1.

The pair of counter electrodes 310-1 and 320-1 may be referred to as a “main electrode”, and the intermediate electrode 330-1 may be referred to as a “sub-electrode”.

A circuit including the pair of counter electrodes 310-1 and 320-1, the intermediate electrode 330-1 and the power supplier 40 may be configured in various ways and thus whether a voltage is applied or not between the pair of counter electrodes 300-1 may vary according to the operation of the power supplier 40.

For example, the pair of counter electrodes 310-1 and 320-1 and the intermediate electrode 330-1 may be connected to a single power supplier 40. By selectively controlling the on/off of a switch of the circuit including the pair of counter electrodes 310-1 and 320-1, the intermediate electrode 330-1, and the power supplier 40, the controller 50 may allow a voltage to be applied between the first side electrode 310-1 and the second side electrode 320-1, or between the first side electrode 310-1 and the intermediate electrode 330-1, or between the second side electrode 320-1 and the intermediate electrode 330-1.

Alternatively, the power supplier 40 may be composed of a plurality of separate modules. For example, the power supplier 40 may be composed of a power supplier configured to apply a voltage between the first side electrode 310-1 and the second side electrode 320-1, a power supplier configured to apply a voltage between the first side electrode 310-1 and the intermediate electrode 330-1, and a power supplier configured to apply a voltage between the second side electrode 320-1 and the intermediate electrode 330-1. The controller 50 may be configured to individually control each power supplier.

When a voltage is applied between the pair of counter electrodes 310-1 and 320-1 in comparison with the case in which a voltage is applied between one of the pair of counter electrodes 310-1 and 320-1 and the intermediate electrode 330-1, the heat generation area of the graphene scroll 200 may be increased and thus the liquid heating performance may be improved.

Accordingly, the at least one power supplier 40 may apply a voltage between either the first side electrode 310-1 or the second side electrode 320-1 and the intermediate electrode 330-1 based on a first condition. In other words, based on the first condition, the controller 50 may control the at least one power supplier 40 to allow a voltage to be applied between one of the pair of counter electrodes 310-1 and 320-1 and the intermediate electrode 330-1. Further, the at least one power supplier 40 may apply a voltage between the first side electrode 310-1 and the second side electrode 320-1 based on a second condition. In other words, based on the second condition, the controller 50 may control the at least one power supplier 40 to allow a voltage to be applied between the pair of counter electrodes 310-1 and 320-1.

The first condition may be a condition for a target temperature of a provided liquid to be relatively low, and the second condition may be a condition for a target temperature of a provided liquid to be relatively high. In other words, when a condition for heating a liquid at a first temperature is referred to as the first condition, a condition for heating a liquid at a second temperature higher than the first temperature may be referred to as the second condition.

For example, the first condition and the second condition may be satisfied based on a user input being obtained through the input device 31 or the dispensing lever 530, respectively. That is, the controller 50 may control the at least one power supplier 40 to allow a voltage to be applied between one of the pair of counter electrodes 310-1 and 320-1 and the intermediate electrode 330-1 based on obtaining a user input, which is for heating the liquid at the first temperature, through the input device 31 or the dispensing lever 530. The controller 50 may control the at least one power supplier 40 to allow a voltage to be applied between the pair of counter electrodes 310-1 and 320-1 based on obtaining a user input, which is for heating the liquid at the second temperature higher than the first temperature, through the input device 31 or the dispensing lever 530.

For example, the graphene scroll 200 may have an overall uniform configuration and heat generation density may be constant. A distance d1 between the first side electrode 310-1 and the intermediate electrode 330-1 and a distance d2 between the second side electrode 320-1 and the intermediate electrode 330-1 may be approximately the same. In this case, the amount of heat generation when a voltage is applied between the first side electrode 310-1 and the intermediate electrode 330-1 and the amount of heat generation when a voltage is applied between the second side electrode 320-1 and the intermediate electrode 330-1 may be approximately the same.

In contrast, the graphene scroll 200 may not have an overall uniform configuration, or the distance d1 between the first side electrode 310-1 and the intermediate electrode 330-1 and the distance d2 between the second side electrode 320-1 and the intermediate electrode 330-1 may be different from each other. At this time, the amount of heat generation when a voltage is applied between the first side electrode 310-1 and the intermediate electrode 330-1 and the amount of heat generation when a voltage is applied between the second side electrode 320-1 and the intermediate electrode 330-1 may be different from each other.

For example, it may be assumed that the heat generation density of a portion of the graphene scroll 200 between the first side electrode 310-1 and the intermediate electrode 330-1 is less than the heat generation density of another portion between the second side electrode 320-1 and the intermediate electrode 330-1 or it may be assumed that the distance d1 between the first side electrode 310-1 and the intermediate electrode 330-1 is less than the distance d2 between the second side electrode 320-1 and the intermediate electrode 330-1. In this case, the amount of heat generation when a voltage is applied between the first side electrode 310-1 and the intermediate electrode 330-1 may be less than the amount of heat generation when a voltage is applied between the second side electrode 320-1 and the intermediate electrode 330-1.

In this case, the at least one power supplier 40 may apply a voltage between the first side electrode 310-1 and the intermediate electrode 330-1 based on a first condition, apply a voltage between the second side electrode 320-1 and the intermediate electrode 330-1 based on a second condition, and apply a voltage between the first side electrode 310-1 and the second side electrode 320-1 based on a third condition. In other words, the controller 50 may be configured to control the at least one power supplier 40 to apply a voltage between the first side electrode 310-1 and the intermediate electrode 330-1 based on the first condition, control the at least one power supplier 40 to apply a voltage between the second side electrode 320-1 and the intermediate electrode 330-1 based on the second condition, and control the at least one power supplier 40 to apply a voltage between the first side electrode 310-1 and the second side electrode 320-1 based on the third condition.

A condition for heating a liquid at a first temperature may be the first condition, a condition for heating a liquid at a second temperature higher than the first temperature may be the second condition, and a condition for heating a liquid at a third temperature higher than the second temperature may be the third condition.

With this configuration, the heater 100 may be configured to heat a liquid at various levels of temperature.

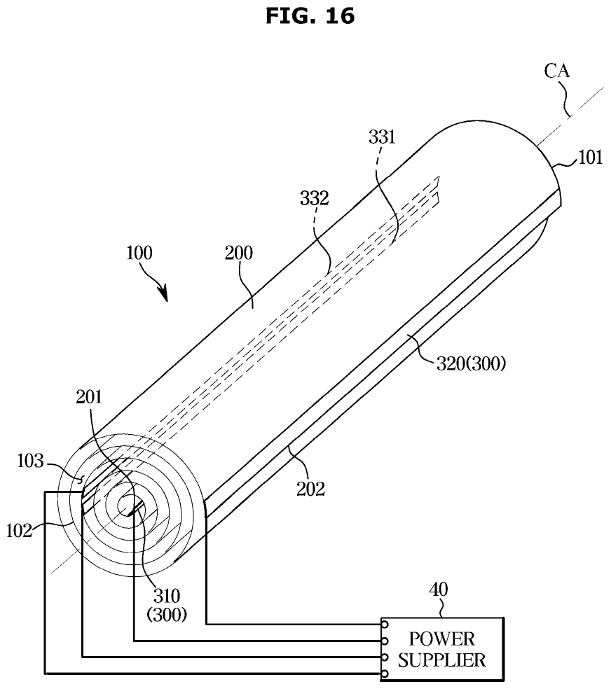

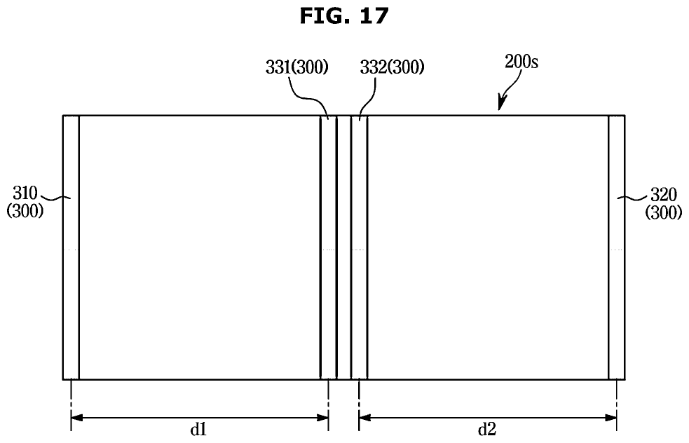

FIG. 16 illustrates a heater included in the water purifier and including four electrodes according to an embodiment of the disclosure. FIG. 17 illustrates a graphene sheet forming a graphene scroll of FIG. 16 and electrodes connected to the graphene sheet according to an embodiment of the disclosure.

When describing an embodiment of the disclosure with reference to FIGS. 16 and 17, the same components as the embodiments of FIGS. 1 to 9 may have the same reference numerals and descriptions thereof may be omitted.

Referring to FIGS. 16 and 17, a heater 100 included in the water purifier 1 according to an embodiment of the disclosure may include a pair of counter electrodes 310 and 320, and a plurality of intermediate electrodes 331 and 332 disposed between the pair of counter electrodes 310 and 320. In other words, the plurality of electrodes 300 may further include the plurality of intermediate electrodes 331 and 332 provided between the first side electrode 310 and the second side electrode 320 as well as the first side electrode 310 and the second side electrode 320. The first side electrode 310, the second side electrode 320, and the plurality of intermediate electrodes 331 and 332 may each be electrically connected to the graphene scroll 200.

Each of the plurality of intermediate electrodes 331 and 332 may be arranged in parallel with each of the first side electrode 310 and the second side electrode 320. Each of the plurality of intermediate electrodes 331 and 332 may extend in a direction parallel to each of the first side electrode 310 and the second side electrode 320. For example, each of the plurality of intermediate electrodes 331 and 332 may extend in a direction parallel to the direction in which the central axis (CA) of the heating flow path 103 extends. As illustrated in FIG. 16, each of the plurality of intermediate electrodes 331 and 332 may extend between the inlet 101 and the outlet 102.

Particularly, the plurality of intermediate electrodes 331 and 332 may include a first intermediate electrode 331 and a second intermediate electrode 332.

The first intermediate electrode 331 may be disposed adjacent to the first side electrode 310. The first intermediate electrode 331 of the plurality of intermediate electrodes 331 and 332 may be an electrode closest to the first side electrode 310. The first intermediate electrode 331 may be disposed between the first side electrode 310 and the second intermediate electrode 332.

The second intermediate electrode 332 may be disposed adjacent to the second side electrode 320. The second intermediate electrode 332 of the plurality of intermediate electrodes 331 and 332 may be an electrode closest to the second side electrode 320. The second intermediate electrode 332 may be disposed between the second side electrode 320 and the first intermediate electrode 331.

That is, as for the plurality of electrodes 300, the first side electrode 310, the first intermediate electrode 331, the second intermediate electrode 332, and the second side electrode 320 may be sequentially arranged.

For example, the first intermediate electrode 331 may be disposed adjacent to the first side electrode 310 between the pair of counter electrodes 310 and 320. However, according to the positions of the first intermediate electrode 331 and the second intermediate electrode 332, the first intermediate electrode 331 may be disposed closer to the second side electrode 320 than the first side electrode 310.

For example, the second intermediate electrode 332 may be disposed adjacent to the second side electrode 320 between the pair of counter electrodes 310 and 320. However, according to the positions of the first intermediate electrode 331 and the second intermediate electrode 332, the second intermediate electrode 332 may be disposed closer to the first side electrode 310 than the second side electrode 320.

The first intermediate electrode 331 and the second intermediate electrode 332 may be arranged to be spaced apart from each other. A distance between the first intermediate electrode 331 and the second intermediate electrode 332 may be significantly less than a distance d1 between the first side electrode 310 and the first intermediate electrode 331 or a distance d2 between the second side electrode 320 and the second intermediate electrode 332.

The first intermediate electrode 331 and the second intermediate electrode 332 may each be electrically connected to the power supplier 40. Accordingly, a voltage may be applied between the first side electrode 310 and the second side electrode 320 by the power supplier 40. Further, a voltage may be applied between the first side electrode 310 and the first intermediate electrode 331 by the power supplier 40. Further, a voltage may be applied between the second side electrode 320 and the second intermediate electrode 332 by the power supplier 40. That is, the power supplier 40 may apply a voltage between the first side electrode 310 and the second side electrode 320, between the first side electrode 310 and the first intermediate electrode 331, or between the second side electrode 320 and the second intermediate electrode 332.

The pair of counter electrodes 310 and 320 may be referred to as a “main electrode”, and the plurality of intermediate electrodes 331 and 332 may be referred to as a “sub-electrode”.

A circuit including the pair of counter electrodes 310 and 320, the plurality of intermediate electrodes 331 and 332 and the power supplier 40 may be configured in various ways and thus whether a voltage is applied or not between the pair of counter electrodes 300 may vary according to the operation of the power supplier 40.

For example, the pair of counter electrodes 310 and 320 and the plurality of intermediate electrodes 331 and 332 may be connected to a single power supplier 40. By selectively controlling the on/off of a switch of the circuit including the pair of counter electrodes 310 and 320, the plurality of intermediate electrodes 331 and 332, and the power supplier 40, the controller 50 may allow a voltage to be applied between the first side electrode 310 and the second side electrode 320, or to be applied between the first side electrode 310 and the first intermediate electrode 331, or to be applied between the second side electrode 320 and the second intermediate electrode 332.

Alternatively, the power supplier 40 may be composed of a plurality of separate modules. For example, the power supplier 40 may be composed of a power supplier configured to apply a voltage between the first side electrode 310 and the second side electrode 320, a power supplier configured to apply a voltage between the first side electrode 310 and the first intermediate electrode 331, and a power supplier configured to apply a voltage between the second side electrode 320 and the second intermediate electrode 332. The controller 50 may be configured to individually control each power supplier.

When a voltage is applied between the first side electrode 310 and the second side electrode 320 in comparison with the case in which a voltage is applied between the first side electrode 310 and the first intermediate electrode 331 or the case in which a voltage is applied between the second side electrode 320 and the second intermediate electrode 332, the heat generation area of the graphene scroll 200 may be increased and thus the liquid heating performance may be improved.

In addition, when a voltage is applied between the first side electrode 310 and the first intermediate electrode 331 and at the same time, a voltage is applied between the second side electrode 320 and the second intermediate electrode 332 in comparison with the case in which a voltage is applied between the first side electrode 310 and the second side electrode 320, a distance between the electrodes may be reduced and thus an intensity of electrical current flowing through the graphene scroll 200 may increase. Further, the amount of heat generation of the graphene scroll 200 may increase and the liquid heating performance may be improved.

Accordingly, at least one power supplier 40 may apply a voltage between the first side electrode 310 and the first intermediate electrode 331 or between the second side electrode 320 and the second intermediate electrode 332 based on a first condition. In other words, based on the first condition, the controller 50 may control the at least one power supplier 40 to allow a voltage to be applied between the first side electrode 310 and the first intermediate electrode 331 or between the second side electrode 320 and the second intermediate electrode 332. Further, the at least one power supplier 40 may apply a voltage between the first side electrode 310 and the second side electrode 320 based on a second condition. In other words, based on the second condition, the controller 50 may control the at least one power supplier 40 to allow a voltage to be applied between the first side electrode 310 and the second side electrode 320. Further, the at least one power supplier 40 may apply a voltage between the first side electrode 310 and the first intermediate electrode 331 and between the second side electrode 320 and the second intermediate electrode 332 based on a third condition. In other words, based on the third condition, the controller 50 may control the at least one power supplier 40 to allow a voltage to be applied between the first side electrode 310 and the first intermediate electrode 331 and between the second side electrode 320 and the second intermediate electrode 332.

A condition for heating a liquid at a first temperature may be the first condition, a condition for heating a liquid at a second temperature higher than the first temperature may be the second condition, and a condition for heating a liquid at a third temperature higher than the second temperature may be the third condition.

For example, the first condition, the second condition and the third condition may be satisfied based on a user input being obtained through the input device 31 or the dispensing lever 530, respectively. That is, the controller 50 may control the at least one power supplier 40 to allow a voltage to be applied between the first side electrode 310 and the first intermediate electrode 331 or between the second side electrode 320 and the second intermediate electrode 332 based on obtaining a user input, which is for heating the liquid at the first temperature, through the input device 31 or the dispensing lever 530. In addition, the controller 50 may control the at least one power supplier 40 to allow a voltage to be applied between the first side electrode 310 and the second side electrode 320 based on obtaining a user input, which is for heating the liquid at the second temperature higher than the first temperature, through the input device 31 or the dispensing lever 530. In addition, the controller 50 may control the at least one power supplier 40 to allow a voltage to be applied between the first side electrode 310 and the first intermediate electrode 331 and between the second side electrode 320 and the second intermediate electrode 332 based on obtaining a user input, which is for heating the liquid at the third temperature higher than the second temperature, through the input device 31 or the dispensing lever 530.

For example, the graphene scroll 200 may have an overall uniform configuration and heat generation density may be constant. The distance d1 between the first side electrode 310 and the first intermediate electrode 331 and the distance d2 between the second side electrode 320 and the second intermediate electrode 332 may be approximately the same. In this case, the amount of heat generation when a voltage is applied between the first side electrode 310 and the first intermediate electrode 331 and the amount of heat generation when a voltage is applied between the second side electrode 320 and the second intermediate electrode 332 may be approximately the same.

In contrast, the graphene scroll 200 may not have an overall uniform configuration, or the distance d1 between the first side electrode 310 and the first intermediate electrode 331 and the distance d2 between the second side electrode 320 and the second intermediate electrode 332 may be different from each other. At this time, the amount of heat generation when a voltage is applied between the first side electrode 310 and the first intermediate electrode 331 and the amount of heat generation when a voltage is applied between the second side electrode 320 and the second intermediate electrode 332 may be different from each other.

For example, it may be assumed that the heat generation density of a portion of the graphene scroll 200 between the first side electrode 310 and the first intermediate electrode 331 is less than the heat generation density of another portion between the second side electrode 320 and the second intermediate electrode 332 or it may be assumed that the distance d1 between the first side electrode 310 and the first intermediate electrode 331 is less than the distance d2 between the second side electrode 320 and the second intermediate electrode 332. In this case, the amount of heat generation when a voltage is applied between the first side electrode 310 and the first intermediate electrode 331 may be less than the amount of heat generation when a voltage is applied between the second side electrode 320 and the second intermediate electrode 332.

In this case, the at least one power supplier 40 may apply a voltage between the first side electrode 310 and the first intermediate electrode 331 based on a first condition, apply a voltage between the second side electrode 320 and the second intermediate electrode 332 based on a second condition, apply a voltage between the first side electrode 310 and the second side electrode 320 based on a third condition, and apply a voltage between the first side electrode 310 and the first intermediate electrode 331 and between the second side electrode 320 and the second intermediate electrode 332 base on a fourth condition. In other words, the controller 50 may be configured to control the at least one power supplier 40 to apply a voltage between the first side electrode 310 and the first intermediate electrode 331 based on the first condition, control the at least one power supplier 40 to apply a voltage between the second side electrode 320 and the second intermediate electrode 332 based on the second condition, control the at least one power supplier 40 to apply a voltage between the first side electrode 310 and the second side electrode 320 based on the third condition, and control the at least one power supplier 40 to apply a voltage between the first side electrode 310 and the first intermediate electrode 331 and between the second side electrode 320 and the second intermediate electrode 332 base on the fourth condition.

A condition for heating a liquid at a first temperature may be the first condition, a condition for heating a liquid at a second temperature higher than the first temperature may be the second condition, a condition for heating a liquid at a third temperature higher than the second temperature may be the third condition, and a condition for heating a liquid at a fourth temperature higher than the third temperature may be the fourth condition.

With this configuration, the heater 100 may be configured to heat a liquid at various levels of temperature.

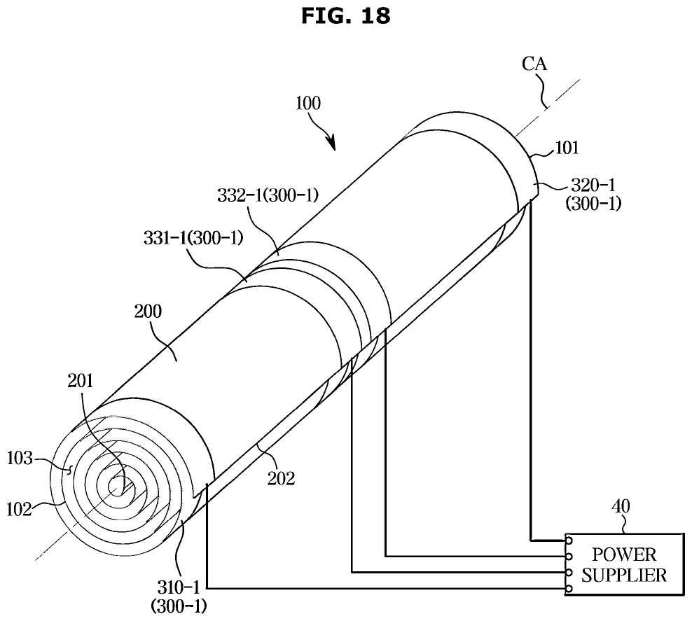

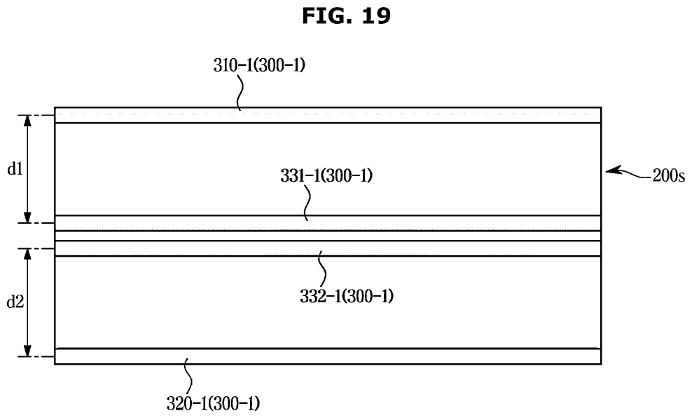

FIG. 18 illustrates a heater included in the water purifier and including four electrodes according to an embodiment of the disclosure. FIG. 19 illustrates a graphene sheet forming a graphene scroll of FIG. 18 and electrodes connected to the graphene sheet according to an embodiment of the disclosure.

When describing an embodiment of the disclosure with reference to FIGS. 18 and 19, the same components as the embodiments of FIGS. 10 and 11 may have the same reference numerals and descriptions thereof may be omitted.

Referring to FIGS. 18 and 19, a heater 100 included in the water purifier 1 according to an embodiment of the disclosure may include a pair of counter electrodes 310-1 and 320-1 and a plurality of intermediate electrodes 331-1 and 332-1 disposed between the pair of counter electrodes 310-1 and 320-1. In other words, the plurality of electrodes 300-1 may further include the plurality of intermediate electrodes 331-1 and 332-1 provided between the first side electrode 310-1 and the second side electrode 320-1 as well as the first side electrode 310-1 and the second side electrode 320-1. The first side electrode 310-1, the second side electrode 320-1, and the plurality of intermediate electrodes 331-1 and 332-1 may each be electrically connected to the graphene scroll 200.

Each of the plurality of intermediate electrodes 331-1 and 332-1 may be arranged in parallel with each of the first side electrode 310-1 and the second side electrode 320-1. Each of the plurality of intermediate electrodes 331-1 and 332-1 may extend in a direction parallel to each of the first side electrode 310-1 and the second side electrode 320-1. For example, the direction in which each of the plurality of intermediate electrodes 331-1 and 332-1 extends may be different from the direction in which the central axis (CA) of the heating flow path 103 extends. Each of the plurality of intermediate electrodes 331-1 and 332-1 may extend in a direction parallel to the direction extending from one end of the graphene scroll 200 adjacent to the central axis (CA) of the heating flow path 103 toward the other end. Each of the plurality of intermediate electrodes 331-1 and 332-1 may extend in a first direction D1 from one end, which is adjacent to the central axis (CA) of the heating flow path 103, of both ends toward the other end. Each of the plurality of intermediate electrodes 331-1 and 332-1 may extend to allow a distance from the central axis (CA) of the heating flow path 103 to increase toward the first direction D1. Each of the plurality of intermediate electrodes 331-1 and 332-1 may be formed in a substantially scroll shape.

The first side electrode 310-1, the plurality of intermediate electrodes 331-1 and 332-1, and the second side electrode 320-1 may be arranged in parallel with the direction in which the inlet 101 and the outlet 102 face each other. The first side electrode 310-1, the intermediate electrode 330-1, and the second side electrode 320-1 may be arranged in parallel with each other in the direction in which the central axis (CA) of the heating flow path 103 extends.

As illustrated in FIG. 18, the plurality of intermediate electrodes 331-1 and 332-1 may be arranged to be spaced apart from each of the inlet 101 and the outlet 102. The plurality of intermediate electrodes 331-1 and 332-1 may be disposed between the inlet 101 and the outlet 102.

Particularly, the plurality of intermediate electrodes 331-1 and 332-1 may include a first intermediate electrode 331-1 and a second intermediate electrode 332-1.

The first intermediate electrode 331-1 may be disposed adjacent to the first side electrode 310-1. The first intermediate electrode 331-1 of the plurality of intermediate electrodes 331-1 and 332-1 may be an electrode closest to the first side electrode 310-1. The first intermediate electrode 331-1 may be disposed between the first side electrode 310-1 and the second intermediate electrode 332-1.

The second intermediate electrode 332-1 may be disposed adjacent to the second side electrode 320-1. The second intermediate electrode 332-1 of the plurality of intermediate electrodes 331-1 and 332-1 may be an electrode closest to the second side electrode 320-1. The second intermediate electrode 332-1 may be disposed between the second side electrode 320-1 and the first intermediate electrode 331-1.

That is, as for the plurality of electrodes 300-1, the first side electrode 310-1, the first intermediate electrode 331-1, the second intermediate electrode 332-1, and the second side electrode 320-1 may be sequentially arranged.

For example, the first intermediate electrode 331-1 may be disposed adjacent to the first side electrode 310-1 between the pair of counter electrodes 310-1 and 320-1. However, according to the positions of the first intermediate electrode 331-1 and the second intermediate electrode 332-1, the first intermediate electrode 331-1 may be disposed closer to the second side electrode 320-1 than the first side electrode 310-1.

For example, the second intermediate electrode 332-1 may be disposed adjacent to the second side electrode 320-1 between the pair of counter electrodes 310-1 and 320-1. However, according to the positions of the first intermediate electrode 331-1 and the second intermediate electrode 332-1, the second intermediate electrode 332-1 may be disposed closer to the first side electrode 310-1 than the second side electrode 320-1.

The first intermediate electrode 331-1 and the second intermediate electrode 332-1 may be arranged to be spaced apart from each other. A distance between the first intermediate electrode 331-1 and the second intermediate electrode 332-1 may be significantly less than a distance d1 between the first side electrode 310-1 and the first intermediate electrode 331-1 or a distance d2 between the second side electrode 320-1 and the second intermediate electrode 332-1.

The first intermediate electrode 331-1 and the second intermediate electrode 332-1 may each be electrically connected to the power supplier 40. Accordingly, a voltage may be applied between the first side electrode 310-1 and the second side electrode 320-1 by the power supplier 40. Further, a voltage may be applied between the first side electrode 310-1 and the first intermediate electrode 331-1 by the power supplier 40. Further, a voltage may be applied between the second side electrode 320-1 and the second intermediate electrode 332-1 by the power supplier 40. That is, the power supplier 40 may apply a voltage between the first side electrode 310-1 and the second side electrode 320-1, between the first side electrode 310-1 and the first intermediate electrode 331-1, or between the second side electrode 320-1 and the second intermediate electrode 332-1.

The pair of counter electrodes 310-1 and 320-1 may be referred to as a “main electrode”, and the plurality of intermediate electrodes 331-1 and 332-1 may be referred to as a “sub-electrode”.

A circuit including the pair of counter electrodes 310-1 and 320-1, the plurality of intermediate electrodes 331-1 and 332-1 and the power supplier 40 may be configured in various ways and thus whether a voltage is applied or not between the pair of counter electrodes 300-1 may vary according to the operation of the power supplier 40.

For example, the pair of counter electrodes 310-1 and 320-1 and the plurality of intermediate electrodes 331-1 and 332-1 may be connected to a single power supplier 40. By selectively controlling the on/off of a switch of the circuit including the pair of counter electrodes 310-1 and 320-1, the plurality of intermediate electrodes 331-1 and 332-1, and the power supplier 40, the controller 50 may allow a voltage to be applied between the first side electrode 310-1 and the second side electrode 320-1, or to be applied between the first side electrode 310-1 and the first intermediate electrode 331-1, or to be applied between the second side electrode 320-1 and the second intermediate electrode 332-1.

Alternatively, the power supplier 40 may be composed of a plurality of separate modules. For example, the power supplier 40 may be composed of a power supplier configured to apply a voltage between the first side electrode 310-1 and the second side electrode 320-1, a power supplier configured to apply a voltage between the first side electrode 310-1 and the first intermediate electrode 331-1, and a power supplier configured to apply a voltage between the second side electrode 320-1 and the second intermediate electrode 332-1. The controller 50 may be configured to individually control each power supplier.

When a voltage is applied between the first side electrode 310-1 and the second side electrode 320-1 in comparison with the case in which a voltage is applied between the first side electrode 310-1 and the first intermediate electrode 331-1 or the case in which a voltage is applied between the second side electrode 320-1 and the second intermediate electrode 332-1, the heat generation area of the graphene scroll 200 may be increased and thus the liquid heating performance may be improved.

In addition, when a voltage is applied between the first side electrode 310-1 and the first intermediate electrode 331-1 and at the same time, a voltage is applied between the second side electrode 320-1 and the second intermediate electrode 332-1 in comparison with the case in which a voltage is applied between the first side electrode 310-1 and the second side electrode 320-1, a distance between the electrodes may be reduced and thus an intensity of electrical current flowing through the graphene scroll 200 may increase. Further, the amount of heat generation of the graphene scroll 200 may increase and the liquid heating performance may be improved.

Accordingly, at least one power supplier 40 may apply a voltage between the first side electrode 310-1 and the first intermediate electrode 331-1 or between the second side electrode 320-1 and the second intermediate electrode 332-1 based on a first condition. In other words, based on the first condition, the controller 50 may control the at least one power supplier 40 to allow a voltage to be applied between the first side electrode 310-1 and the first intermediate electrode 331-1 or between the second side electrode 320-1 and the second intermediate electrode 332-1. Further, the at least one power supplier 40 may apply a voltage between the first side electrode 310-1 and the second side electrode 320-1 based on a second condition. In other words, based on the second condition, the controller 50 may control the at least one power supplier 40 to allow a voltage to be applied between the first side electrode 310-1 and the second side electrode 320-1. Further, the at least one power supplier 40 may apply a voltage between the first side electrode 310-1 and the first intermediate electrode 331-1 and between the second side electrode 320-1 and the second intermediate electrode 332-1 based on a third condition. In other words, based on the third condition, the controller 50 may control the at least one power supplier 40 to allow a voltage to be applied between the first side electrode 310-1 and the first intermediate electrode 331-1 and between the second side electrode 320-1 and the second intermediate electrode 332-1.

A condition for heating a liquid at a first temperature may be the first condition, a condition for heating a liquid at a second temperature higher than the first temperature may be the second condition, and a condition for heating a liquid at a third temperature higher than the second temperature may be the third condition.

For example, the first condition, the second condition and the third condition may be satisfied based on a user input being obtained through the input device 31 or the dispensing lever 530, respectively. That is, the controller 50 may control the at least one power supplier 40 to allow a voltage to be applied between the first side electrode 310-1 and the first intermediate electrode 331-1 or between the second side electrode 320-1 and the second intermediate electrode 332-1 based on obtaining a user input, which is for heating the liquid at the first temperature, through the input device 31 or the dispensing lever 530. In addition, the controller 50 may control the at least one power supplier 40 to allow a voltage to be applied between the first side electrode 310-1 and the second side electrode 320-1 based on obtaining a user input, which is for heating the liquid at the second temperature higher than the first temperature, through the input device 31 or the dispensing lever 530. In addition, the controller 50 may control the at least one power supplier 40 to allow a voltage to be applied between the first side electrode 310-1 and the first intermediate electrode 331-1 and between the second side electrode 320-1 and the second intermediate electrode 332-1 based on obtaining a user input, which is for heating the liquid at the third temperature higher than the second temperature, through the input device 31 or the dispensing lever 530.

For example, the graphene scroll 200 may have an overall uniform configuration and heat generation density may be constant. A distance d1 between the first side electrode 310-1 and the first intermediate electrode 331-1 and a distance d2 between the second side electrode 320-1 and the second intermediate electrode 332-1 may be approximately the same. In this case, the amount of heat generation when a voltage is applied between the first side electrode 310-1 and the first intermediate electrode 331-1 and the amount of heat generation when a voltage is applied between the second side electrode 320-1 and the second intermediate electrode 332-1 may be approximately the same.

In contrast, the graphene scroll 200 may not have an overall uniform configuration, or the distance d1 between the first side electrode 310-1 and the first intermediate electrode 331-1 and the distance d2 between the second side electrode 320-1 and the second intermediate electrode 332-1 may be different from each other. At this time, the amount of heat generation when a voltage is applied between the first side electrode 310-1 and the first intermediate electrode 331-1 and the amount of heat generation when a voltage is applied between the second side electrode 320-1 and the second intermediate electrode 332-1 may be different from each other.

For example, it may be assumed that the heat generation density of a portion of the graphene scroll 200 between the first side electrode 310-1 and the first intermediate electrode 331-1 is less than the heat generation density of another portion between the second side electrode 320-1 and the second intermediate electrode 332-1 or it may be assumed that the distance d1 between the first side electrode 310-1 and the first intermediate electrode 331-1 is less than the distance d2 between the second side electrode 320-1 and the second intermediate electrode 332-1. In this case, the amount of heat generation when a voltage is applied between the first side electrode 310-1 and the first intermediate electrode 331-1 may be less than the amount of heat generation when a voltage is applied between the second side electrode 320-1 and the second intermediate electrode 332-1.

In this case, the at least one power supplier 40 may apply a voltage between the first side electrode 310-1 and the first intermediate electrode 331-1 based on a first condition, apply a voltage between the second side electrode 320-1 and the second intermediate electrode 332-1 based on a second condition, apply a voltage between the first side electrode 310-1 and the second side electrode 320-1 based on a third condition, and apply a voltage between the first side electrode 310-1 and the first intermediate electrode 331-1 and between the second side electrode 320-1 and the second intermediate electrode 332-1 base on a fourth condition. In other words, the controller 50 may be configured to control the at least one power supplier 40 to apply a voltage between the first side electrode 310-1 and the first intermediate electrode 331-1 based on the first condition, control the at least one power supplier 40 to apply a voltage between the second side electrode 320-1 and the second intermediate electrode 332-1 based on the second condition, control the at least one power supplier 40 to apply a voltage between the first side electrode 310-1 and the second side electrode 320-1 based on the third condition, and control the at least one power supplier 40 to apply a voltage between the first side electrode 310-1 and the first intermediate electrode 331-1 and between the second side electrode 320-1 and the second intermediate electrode 332-1 base on the fourth condition.

A condition for heating a liquid at a first temperature may be the first condition, a condition for heating a liquid at a second temperature higher than the first temperature may be the second condition, a condition for heating a liquid at a third temperature higher than the second temperature may be the third condition, and a condition for heating a liquid at a fourth temperature higher than the third temperature may be the fourth condition.

With this configuration, the heater 100 may be configured to heat a liquid at various levels of temperature.

FIG. 20 is a cross-sectional view illustrating a portion of a water purifier according to an embodiment of the disclosure.

Referring to FIG. 20, a heater 100-2 of the water purifier 1 according to an embodiment of the disclosure may include an inlet 101-2 through which a liquid (e.g., purified water) flows into the heater 100-2 and an outlet 102-2 through which a liquid is discharged from the heater 100-2. A heating flow path 103-2 through which a liquid is heated may be formed between the inlet 101-1 and the outlet 102-2. A liquid may flow along the heating flow path 103-2.

The heater 100-2 may include at least one graphene scroll 200-2. The heating flow path 103-2 may be formed by the at least one graphene scroll 200-2. The at least one graphene scroll 200-2 may be configured to heat the liquid flowing along the heating flow path 103-2. The at least one graphene scroll 200-2 may be configured to generate heat based on an applied voltage.

As illustrated in FIG. 20, a width r2 of the outlet 102-2 of the heater 100-2 may be less than a width r1 of the inlet 101-2. In other words, a cross-sectional area of the outlet 102-1 may be less than a cross-sectional area of the inlet 101-1.

Accordingly, a cross-sectional area of one side of the heating flow path 103-2 adjacent to the outlet 102-2 may be less than a cross-sectional area of the other side of the heating flow path 103-2 adjacent to the inlet 101-2. As illustrated in FIG. 20, the heating flow path 103-2 may be formed to have a narrower width from the inlet 101-2 toward the outlet 102-2.

As illustrated in FIG. 20, a width of the heating flow path 103-2 may decrease at a constant rate from the inlet 101-2 toward the outlet 102-2, but is not limited thereto.

In other words, the graphene scroll 200-2 may be formed to allow a cross-sectional area of the heating flow path 103-2 on the side adjacent to the outlet 102-2 to be less than a cross-sectional area of the heating flow path 103-2 on the side adjacent to the inlet 101-2.

The width of the heating flow path 103-2, the width r1 of the inlet 101-2, and the width r2 of the outlet 102-2 refer to a width measured in a direction perpendicular to the central axis (CA) of the heating flow path 103-2.

In addition, the cross-sectional area of the heating flow path 103-2, the cross-sectional area of the inlet 101-2, and the cross-sectional area of the outlet 102-2 refer to an area of a cross section that is cut into a plane perpendicular to the central axis (CA) of the heating flow path 103-2.

With this configuration, a flow rate of the liquid flowing in through the outlet 102-2 may be greater than a flow rate of the liquid flowing in through the inlet 101-2, and thus the water purifier 1 may provide purified water at a faster rate.

In the above, the configuration of the water purifier including the heater is described with reference to FIGS. 1 to 20. However, the configuration described above may be applied to various devices (e.g., humidifiers, steam ovens, dishwashers, steam cleaners, clothes care apparatuses, etc.) that are configured to heat water using the heater.

In addition, the configuration described above may be applied to various types of dispensing devices configured to heat not only water but also beverages such as coffee and milk and other liquids using a heater, and configured to provide the heated water, beverages and other liquids.

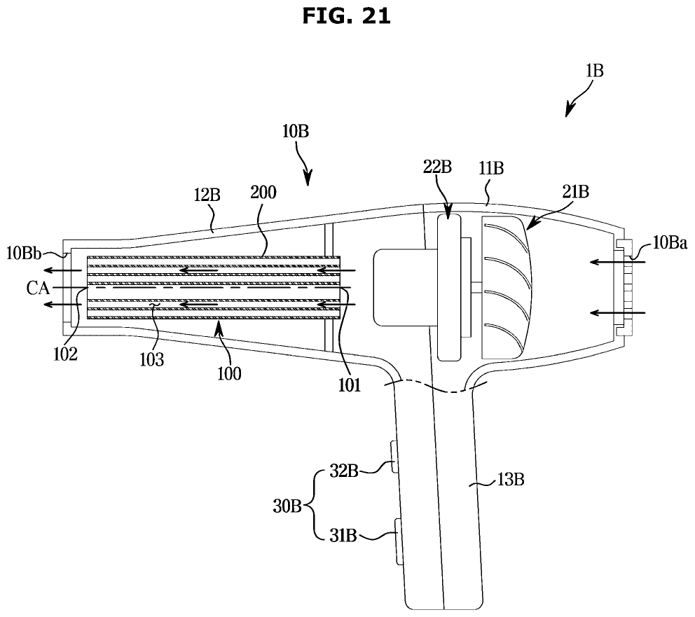

Hereinafter a hot air blower will be described as an example of a device configured to heat gas using a heater with reference to FIGS. 21 to 23.

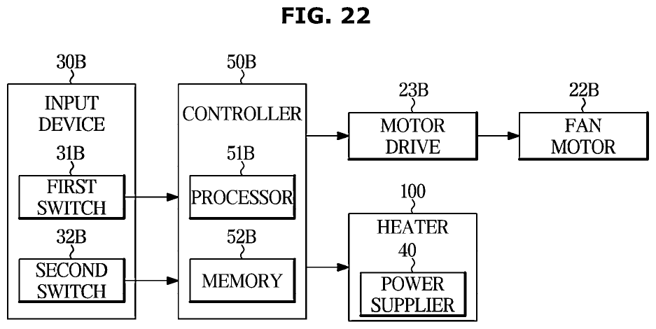

FIG. 21 is a cross-sectional view illustrating a hot air blower according to an embodiment of the disclosure. FIG. 22 is a block diagram illustrating some configurations of the hot air blower according to an embodiment of the disclosure.

Referring to FIGS. 21 and 22, a hot air blower 1B according to an embodiment of the disclosure may include a main body 10B, a fan 21B, and a heater 100.

The main body 10B may form an exterior of the hot air blower 1B. Various components of the hot air blower 1B may be disposed inside the main body 10B. The main body 10B may accommodate and support various components of the hot air blower 1B.

The main body 10B may form a flow path through which air flows. The flow path may be disposed inside the main body 10B. Particularly, the main body 10B may include a main body inlet 10Ba through which air flows into the main body 10B, and a main body outlet 10Bb through which air is discharged from the inside of the main body 10B. The flow path inside the main body 10B may be formed between the main body inlet 10Ba and the main body outlet 10Bb. The flow path inside the main body 10B may extend from the main body inlet 10Ba to the main body outlet 10Bb, and the air flowing into the main body 10B through the main body inlet 10Ba may flow along the flow path and then be discharged to the outside of the main body 10B through the main body outlet 10Bb.

For example, the main body inlet 10Ba may include one or more holes formed to allow air to pass through. For example, the main body outlet 10Bb may include one or more holes formed to allow air to pass through.

The fan 21B of the hot air blower 1B may be disposed inside the main body 10B. The fan 21B may be disposed inside the main body 10B to be rotatable with respect to the main body 10B. The fan 21B may generate a pressure difference to allow air to flow along the flow path inside the main body 10B. When the fan 21B rotates with respect to the main body 10B, the air outside the main body 10B may flow in through the main body inlet 10Ba and then be discharged through the main body outlet 10Bb due to the pressure difference generated by the fan 21B.

The hot air blower 1B may include a fan motor 22B configured to generate power to rotate the fan 21B. The fan motor 22B may be configured to convert electromagnetic force into mechanical rotational force. The fan 21B may rotate with respect to the main body 10B by receiving power generated by the fan motor 22B.

For example, the fan motor 22B may include a stator with a coil, a rotor with magnetism and configured to be rotated by electromagnetic force, and a rotor shaft connecting the rotor and the fan 21B. When a driving voltage is applied to the fan motor 22B, the electromagnetic force between the stator and the rotor may be converted into rotational force, thereby allowing the rotor to rotate. Power generated as the rotor rotates may be transmitted to the fan 21B through the rotor shaft, and the fan 21B may rotate around the rotor shaft.

For example, the fan 21B may include various types of fans such as axial fans and centrifugal fans.

The fan 21B and the fan motor 22B may be supported by the main body 10B inside the main body 10B. For example, the main body 10B may include a fan housing 11B in which the fan 21B and the fan motor 22B are accommodated. The fan 21B and the fan motor 22B may be supported by the fan housing 11B. At least a portion of a flow path of air flowing from the main body inlet 10Ba to the main body outlet 10Bb may be formed in the fan housing 11B.

For example, the above-described main body inlet 10Ba may be formed in the fan housing 11B.

The heater 100 of the hot air blower 1B may be configured to generate heat. The heater 100 may be configured to heat air by generating heat. The heater 100 may be configured to generate heat based on an applied voltage.

The heater 100 may be disposed in the main body 10B. The heater 100 may be configured to heat air flowing through the internal flow path of the main body 10B. The heater 100 may be configured to heat air that flows in through the main body inlet 10Ba and flows toward the main body outlet 10Bb when the fan 21B rotates.

For example, the main body 10B may include a duct 12B. The duct 12B may be arranged between the main body inlet 10Ba and the main body outlet 10Bb. At least a portion of a flow path of air flowing from the main body inlet 10Ba to the main body outlet 10Bb may be formed in the duct 12B.

The duct 12B may be connected to the fan housing 11B. The inside of the duct 12B and the inside of the fan housing 11B may be connected to each other. For example, the above-described main body outlet 10Bb may be formed in the duct 12B. That is, when the fan 21B rotates, the air introduced through the main body inlet 10Ba of the fan housing 11B may sequentially pass through the fan housing 11B and the duct 12B and be discharged through the main body outlet 10Bb.

At this time, as illustrated in FIG. 21, the heater 100 may be disposed inside the duct 12B. That is, the heater 100 may be configured to heat air flowing along the duct 12B.

The heater 100 may be supported by the duct 12B. Although not shown in FIG. 21, various structures to support the heater 100 may be provided inside the duct 12B. For example, a heater support portion provided to surround an outer circumferential surface of the heater 100 to fix the heater 100 may be disposed inside the duct 12B. The heater support portion may be coupled to an inner circumferential surface of the duct 12B. Alternatively, the heater support portion may be formed integrally with the inner circumferential surface of the duct 12B.

The heater 100 may include an inlet 101 through which air flows into the heater 100, and an outlet 102 through which air is discharged from the heater. When the fan 21B rotates and air flows inside the main body 10B, the air may flow into the heater 100 through the inlet 101, be heated, and then be discharged through the outlet 102.

The inlet 101 may be located downstream of the flow path from the main body inlet 10Ba. The outlet 102 may be located upstream of the flow path from the main body outlet 10Bb. The inlet 101 may be located upstream of the flow path from the outlet 102.

The inlet 101 may be disposed on one side of the heater 100. For example, the inlet 101 may be disposed on one side, which is adjacent to the fan 21B, of the heater 100. For example, the inlet 101 may be disposed on one side, which is adjacent to the main body inlet 10Ba, of the heater 100.

The outlet 102 may be disposed on the other side opposite to the one side in which the inlet 101 of the heater 100 is located. For example, the outlet 102 may be disposed on one side, which is adjacent to the main body outlet 10Bb, of the heater 100.

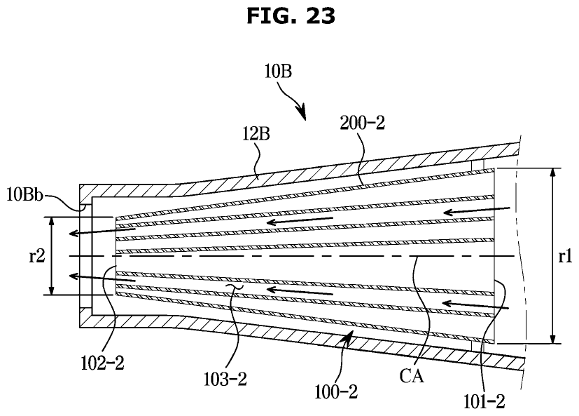

For example, a width of the inlet 101 may approximately correspond to a width of the outlet 102. In other words, a cross-sectional area of the inlet 101 may approximately correspond to a cross-sectional area of the outlet 102. Alternatively, the width of the inlet 101 may be different from the width of the outlet 102. For example, the width of the inlet 101 may be greater or less than the width of the outlet 102 (e.g., refer to FIG. 23).

The heater 100 may be formed to have a bar shape extending in one direction. For example, the heater 100 may extend linearly between the inlet 101 and the outlet 102 along a direction in which the inlet 101 and the outlet 102 face each other. However, the disclosure is not limited thereto, and the heater 100 may extend between the inlet 101 and the outlet 102 to have a shape in which at least a portion of the heater 100 is curved.

The heater 100 may form a heating flow path 103. The heating flow path 103 may form at least a portion of the flow path inside the above-described main body 10B. The heating flow path 103 may be disposed between the main body inlet 10Ba and the main body outlet 10Bb. When the fan 21B rotates, air may pass through the heating flow path 103, and the heater 100 may heat the air passing through the heating flow path 103.

The heating flow path 103 may extend between the inlet 101 and the outlet 102 of the heater 100. The heating flow path 103 may be disposed inside the heater 100. The heating flow path 103 may be provided in a space formed inside the heater 100. The outer circumferential surface of the heater 100 may be formed to have a shape surrounding the heating flow path 103. Heat generated from the heater 100 may be transferred to the heating flow path 103 inside the heater 100 so as to heat the air. When the fan 21B rotates, the air flowing into the heater 100 through the inlet 101 may flow along the heating flow path 103 and then be discharged from the heater 100 through the outlet 102.

For example, the heating flow path 103 may extend in one direction, but is not limited thereto. Alternatively, the direction in which the heating flow path 103 extends may vary according to the shape of the heater 100, the positions of the inlet 101 and the outlet 102, etc.

As mentioned above, as the fan 21B rotates, air may be introduced and discharged and the heater 100 may heat the air by generating heat. Accordingly, the hot air blower 1B may provide hot air.

The hot air blower 1B may include a handle 13B. The handle 13B may be provided to allow a user to easily hold the handle 13B. A user can lift or move the hot air blower 1B by holding the handle 13B. For example, the handle 13B may be provided with one or more switches (e.g., a first switch 31B and a second switch 32B, which will be described later). For example, various electronic components may be disposed inside the handle 13B. For example, electronic components disposed inside the handle 13B may be connected to the fan motor 22B, the heater 100, etc. through a wire. For this, the inside of the handle 13, the inside of the fan housing 11, and the inside of the duct 12 may be connected to each other.

The hot air blower 1B may include a controller 50B configured to control various components of the hot air blower 1B.

The controller 50B may include a processor 51B configured to generate a control signal related to the operation of the hot air blower 1B, and a memory 52B configured to store programs, applications, instructions, and/or data for the operation of the hot air blower 1B. The processor 51B and the memory 52B may be implemented as separate semiconductor devices or as a single semiconductor device.

Additionally, the controller 50B may include a plurality of processors or a plurality of memories. The controller 50B may be disposed at various locations inside the hot air blower 1B.

The processor 51B may include arithmetic circuitry, memory circuitry, and control circuitry. The processor 51B may include one chip or multiple chips. Additionally, the processor 51B may include one core or a plurality of cores.

The memory 52B may store various programs and data required for control, and may temporarily store temporary data generated during control.

The memory 52B may include volatile memory such as Static Random Access Memory (S-RAM), and Dynamic Random Access Memory (D-RAM), and non-volatile memory such as Read Only Memory (ROM), and Erasable Programmable Read Only Memory (EPROM). The memory 52B may include one memory element or a plurality of memory elements.

The processor 51B may be electrically connected to the memory 52B. The processor 51B may process data and/or signals using a program provided from the memory 52B, and may transmit control signals to each component of the hot air blower 1B based on the processing results. Each component of the hot air blower 1B may be operated based on a control signal from the processor 51B.

The hot air blower 1B may include an input device 30B for receiving a user input. Types of user input that is received through the input device 30B may include on/off of the power of the hot air blower 1B, wind strength (i.e., rotation speed of the fan 21B), and wind temperature (i.e., heat generation level of the heater 100), etc.

The input device 30B may include various types of input devices such as a tact switch, a push switch, a slide switch, a toggle switch, a micro switch, or a touch switch.

The input device 30B may receive a user input, output an electrical signal (voltage or electrical current) corresponding to the user input, and transmit the electrical signal to the controller 50B. The controller 50B may receive a user input based on the output signal of the input device 30B.

For example, the input device 30B may include a first switch 31B and a second switch 32B. The first switch 31B and the second switch 32B may be configured to obtain different types of user input.

For example, the first switch 31B may obtain a user input including on/off of the power of the hot air blower 1B, wind strength, etc.

For example, the second switch 32B may obtain a user input including wind temperature, etc.

The hot air blower 1B may include a motor drive 23B configured to apply a driving voltage to the fan motor 22B. The motor drive 23B may be electrically connected to the fan motor 22B.

The controller 50B may be electrically connected to motor drive 23B. The controller 50B may control the motor drive 23B to apply or not apply a driving voltage to the fan motor 22B based on a predetermined condition. The motor drive 23B may receive a target speed command or a torque command from the controller 50B, and may apply a driving voltage corresponding to the target speed command or the target torque command to the fan motor 22B.

The predetermined condition may include a user input obtained through the first switch 31B. For example, when a user input, which is for turning on the power of the hot air blower 1B and for blowing wind of a specific strength, is obtained through the first switch 31B, the controller 50B may control the motor drive 23B to allow the fan motor 22B to rotate at a rotation speed corresponding to the wind of the corresponding strength. Further, when a user input, which is for turning off the power of the hot air blower 1B, is obtained through the first switch 31B, the controller 50B may control the motor drive 23B to allow the rotation of the fan motor 22B to stop.

The controller 50B may be electrically connected to the power supplier 40 of the heater 100. The controller 50B may control the power supplier 40B to apply or not apply a voltage between the plurality of electrodes 300 based on a predetermined condition.

The predetermined condition may include a user input obtained through the second switch 32B. For example, when a user input, which is for discharging high-temperature wind, is obtained through the second switch 32B, the controller 50B may control the power supplier 40 to allow a voltage to be applied between the plurality of electrodes 300 to allow the heater 100 to heat air at a temperature within a predetermined range. Further, when a user input, which is for discharging low-temperature wind, is obtained through the second switch 32B, the controller 50B may control the power supplier 40 to allow a voltage not to be applied between the plurality of electrodes 300 or to allow a magnitude of voltage to be reduced.

The configuration of the heater 100 including the graphene scroll 200 and the electrode 300 may correspond to the heater 100 applied to the water purifier 1 described with reference to FIGS. 3 to 19, and thus a detailed description thereof is omitted.

The configuration of the hot air blower 1B described with reference to FIGS. 21 and 22 is merely an example of the hot air blower according to the disclosure, and the disclosure is not limited thereto.

FIG. 21 illustrates an embodiment in which the heater 100 is disposed inside the duct 12B to heat air at a location very close to the main body outlet 10Bb according to an embodiment of the disclosure. However, the location of the heater 100 is not limited thereto. The heater 100 may be arranged at various locations within the main body 10B to heat air.

FIG. 23 is a cross-sectional view illustrating a portion of a hot air blower according to an embodiment of the disclosure.

Referring to FIG. 23, a heater 100-2 of the hot air blower 1B according to an embodiment of the disclosure may include an inlet 101-2 through which air flows into the heater 100-2, and an outlet 102-2 through which air is discharged from the heater 100-2. A heating flow path 103-2 in which air is heated may be formed between the inlet 101-2 and the outlet 102-2. Air may flow along the heating flow path 103-2.

The heater 100-2 may include at least one graphene scroll 200-2. The heating flow path 103-2 may be formed by the at least one graphene scroll 200-2. The at least one graphene scroll 200-2 may be configured to heat air flowing along the heating flow path 103-2. The at least one graphene scroll 200-2 may be configured to generate heat based on an applied voltage.

As illustrated in FIG. 23, a width r2 of the outlet 102-2 of the heater 100-2 may be less than a width r1 of the inlet 101-2. In other words, a cross-sectional area of the outlet 102-2 may be less than a cross-sectional area of the inlet 101-2.

Accordingly, a cross-sectional area of one side of the heating flow path 103-2 adjacent to the outlet 102-2 may be less than a cross-sectional area of the other side of the heating flow path 103-2 adjacent to the inlet 101-2. As illustrated in FIG. 23, the heating flow path 103-2 may be formed to have a narrower width from the inlet 101-2 toward the outlet 102-2.

As illustrated in FIG. 23, a width of the heating flow path 103-2 may decrease at a constant rate from the inlet 101-2 toward the outlet 102-2, but is not limited thereto.

In other words, the graphene scroll 200-2 may be formed to allow a cross-sectional area of the heating flow path 103-2 on the side adjacent to the outlet 102-2 to be less than a cross-sectional area of the heating flow path 103-2 on the side adjacent to the inlet 101-2.

The width of the heating flow path 103-2, the width r1 of the inlet 101-2, and the width r2 of the outlet 102-2 refer to a width measured in a direction perpendicular to the central axis (CA) of the heating flow path 103-2.

In addition, the cross-sectional area of the heating flow path 103-2, the cross-sectional area of the inlet 101-2, and the cross-sectional area of the outlet 102-2 refer to an area of a cross section that is cut into a plane perpendicular to the central axis (CA) of the heating flow path 103-2.

With this configuration, a flow rate of the air flowing in through the outlet 102-2 may be greater than a flow rate of the air flowing in through the inlet 101-2, and thus the hot air blower 1 may provide hot air at a faster rate.

In the same manner as the embodiments of FIGS. 21 to 23, the heater configurations described with reference to FIGS. 5 to 20 may also be applied to various devices configured to heat gas using a heater.

The configurations described above may be applied to various types of devices including a heater configured to heat a fluid having various phases including gas and liquid.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Storage medium readable by machine may be provided in the form of a non-transitory storage medium. “Non-transitory” means that the storage medium is a tangible device and does not contain a signal (e.g., electromagnetic wave), and this term includes a case in which data is semi-permanently stored in a storage medium and a case in which data is temporarily stored in a storage medium. For example, a “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

The heater according to one embodiment, which is configured to heat a fluid, may include the graphene scroll forming the heating flow path extending between the inlet through which the fluid flows into the heater and the outlet through which the fluid flows out of the heater, and configured to generate heat in response to an electrical current, and the electrode configured to apply a voltage to the graphene scroll. The electrode may include the first side electrode electrically connected to the graphene scroll, the second side electrode electrically connected to the graphene scroll and opposite to the first side electrode, and the intermediate electrode electrically connected to the graphene scroll and disposed between the first side electrode and the second side electrode.

The heater may further include the at least one power supplier provided to be electrically connected to the first side electrode, the second side electrode, and the intermediate electrode. The at least one power supplier may be configured to apply a voltage between the first side electrode and the second side electrode, apply a voltage between the first side electrode and the intermediate electrode, or apply a voltage between the second side electrode and the intermediate electrode.

The at least one power supplier may be configured to apply a voltage between, either the first side electrode or the second side electrode, and the intermediate electrode, based on a first condition that is for heating the fluid at a first temperature. The at least one power supplier may be configured to apply a voltage between the first side electrode and the second side electrode, based on a second condition that is for heating the fluid at a second temperature higher than the first temperature.

The intermediate electrode may include the first intermediate electrode between the first side electrode and the second side electrode and closer to the first side electrode than the second side electrode, and the second intermediate electrode disposed between the first side electrode and the second side electrode, closer to the second side electrode than the first side electrode, and spaced apart from the first intermediate electrode.

The heater may further include at least one power supplier provided to be electrically connected to the first side electrode, the second side electrode, the first intermediate electrode, and the second intermediate electrode. The at least one power supplier may be configured to apply a voltage between the first side electrode and the second side electrode, apply a voltage between the first side electrode and the first intermediate electrode, or apply a voltage between the second side electrode and the second intermediate electrode.

The at least one power supplier may be configured to apply a voltage between the first side electrode and the first intermediate electrode, or between the second side electrode and the second intermediate electrode, based on a first condition for heating the fluid at the first temperature. The at least one power supplier may be configured to apply a voltage between the first side electrode and the second side electrode, based on second condition for heating the fluid at the second temperature higher than the first temperature. The at least one power supplier may be configured to apply a voltage between the first side electrode and the first intermediate electrode, and between the second side electrode and the second intermediate electrode, based on a third condition for heating the fluid at the third temperature higher than the second temperature.

The distance between the first side electrode and the intermediate electrode may be equal to the distance between the second side electrode and the intermediate electrode.

The distance between the first side electrode and the intermediate electrode may be different than the distance between the second side electrode and the intermediate electrode.

One end of the graphene scroll is disposed adjacent to the central axis of the heating flow path, which extends between the inlet and the outlet, and the graphene scroll may extend from the end of the graphene scroll so that a distance from the central axis of the heating flow path to increase. At least a portion of the heating flow path may be formed between a portion of the graphene scroll and another portion of the graphene scroll that covers the portion of the rolled graphene scroll in the outer direction.

The graphene scroll may include the first portion extending in the first direction from one side, which is adjacent to the end of the graphene scroll, and the second portion extending from the first portion in the first direction and. The second portion of the graphene scroll may cover the first portion of the graphene scroll in the outer direction. The at least a portion of the heating flow path may be formed in the space between the first portion of the graphene scroll and the second portion of the graphene scroll.

The heater may further include the spacer disposed between the first portion of the graphene scroll and the second portion of the graphene scroll and provided to maintain the space between the first portion of the graphene scroll and the second portion of the graphene scroll.

The spacer may protrude from the first portion of the graphene scroll toward the second portion of the graphene scroll in the direction away from the central axis of the heating flow path, and the spacer may support the second portion of the graphene scroll.

The graphene scroll may further include the support layer disposed on one surface of the second portion of the graphene scroll facing the first portion of the graphene scroll. The spacer may protrude from a portion of the support layer, which is provided in the second portion of the graphene scroll, toward the first portion of the graphene scroll in the direction toward the central axis of the heating flow path, and the spacer may support the first portion of the graphene scroll.

The first side electrode, the second side electrode, and the intermediate electrode each may extend in a direction parallel to a direction in which the heating flow path between from the inlet and the outlet.

The first side electrode, the second side electrode, and the intermediate electrode each may extend in a direction parallel to a direction in which the graphene scroll extends from one end of the graphene scroll, which is disposed adjacent to a central axis of the heating flow path, toward another end of the graphene scroll.

The water purifier according to an embodiment may include the dispenser configured to provide purified water and the heater configured to heat the purified water. The heater may include the graphene scroll forming the heating flow path extending between the inlet through which purified water flows into the heater and the outlet through which purified water flows out of the heater, and configured to generate heat in response to an electrical current, and the electrode provided in contact with the graphene scroll so as to apply a voltage to the graphene scroll. The electrode may include the first side electrode electrically connected to the graphene scroll, the second side electrode electrically connected to the graphene scroll and opposite to the first side electrode, and the intermediate electrode electrically connected to the graphene scroll and disposed between the first side electrode and the second side electrode.

The intermediate electrode may include the first intermediate electrode disposed adjacent to the first side electrode between the first side electrode and the second side electrode, and the second intermediate electrode disposed adjacent to the second side electrode between the first side electrode and the second side electrode and spaced apart from the first intermediate electrode.

The dispenser may further include the nozzle through which purified water is discharged. The heater may be detachably mounted to the nozzle.

The hot air blower according to an embodiment may include the main body, the fan disposed in the main body, and the heater disposed in the main body and configured to heat air moved by the fan. The heater may include the graphene scroll forming the heating flow path extending between the inlet through which air flows into the heater and the outlet through which air flows out of the heater, and configured to generate heat in response to an electrical current, and the electrode configured to apply a voltage to the graphene scroll. The electrode may include the first side electrode electrically connected to the graphene scroll, the second side electrode electrically connected to the graphene scroll and opposite to the first side electrode, and the intermediate electrode electrically connected to the graphene scroll and disposed between the first side electrode and the second side electrode.

The graphene scroll may be formed to allow the cross-sectional area of the heating flow path on the side adjacent to the outlet to be less than the cross-sectional area of the heating flow path on the side adjacent to the inlet.

As is apparent from the above description, a heater may use a graphene heating element with good heat generation efficiency as a heat source so as to improve liquid heating efficiency.

Further, a heater may use a graphene heating element with good heat generation efficiency as a heat source so as to reduce power consumption of the heater.

Further, a heater may use a graphene heating element, which quickly heats when a voltage is applied and quickly returns to an original temperature when a voltage is stopped, as a heat source so as to improve a rate of temperature change of the heater.

Further, a heater may include a graphene scroll in the shape in which a graphene sheet is rolled into a scroll shape, and thus a heat generation area may be increased and liquid heating efficiency may be improved.

Further, a heater may include a spacer so as to prevent a graphene scroll from being deformed.

Further, a heater may include an electrode that is electrically connected to a graphene scroll and provided to apply a voltage, and thus the heat generation may be easily controlled.

Further, various numbers of electrodes may be variously arranged on a graphene scroll, and thus the heat generation of a heater may be easily controlled.

Further, a heater may be provided to allow a cross-sectional area of an outlet to be less than a cross-sectional area of an inlet, and thus a speed of a fluid discharged through the outlet may increase.

Additional aspects of the disclosure will be set forth in part in the description which follows and, in part, will be obvious from the description, or may be learned by practice of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A heater configured to heat a fluid comprising:
a graphene scroll forming a heating flow path extending between an inlet through which the fluid flows into the heater and an outlet through which the fluid flows out of the heater, and configured to generate heat in response to an electrical current flowing therethrough; and
an electrode configured to apply a voltage to the graphene scroll,
wherein the electrode includes:
a first side electrode electrically connected to the graphene scroll,
a second side electrode electrically connected to the graphene scroll and opposite to the first side electrode, and
an intermediate electrode electrically connected to the graphene scroll and disposed between the first side electrode and the second side electrode.

2. The heater of claim 1, further comprising:
at least one power supplier provided to be electrically connected to the first side electrode, the second side electrode, and the intermediate electrode,
wherein the at least one power supplier is configured to:
apply a voltage between the first side electrode and the second side electrode,
apply a voltage between the first side electrode and the intermediate electrode, or
apply a voltage between the second side electrode and the intermediate electrode.

3. The heater of claim 2, wherein the at least one power supplier is configured to:
apply a voltage between, either the first side electrode or the second side electrode, and the intermediate electrode, based on a first condition that is for heating the fluid at a first temperature, and
apply a voltage between the first side electrode and the second side electrode, based on a second condition that is for heating the fluid at a second temperature higher than the first temperature.

4. The heater of claim 1, wherein the intermediate electrode includes:
a first intermediate electrode disposed between the first and the second side electrode and closer to the first side electrode than the second side electrode, and
a second intermediate electrode disposed between the first side electrode and the second side electrode, closer to the second side electrode than the first side electrode, and spaced apart from the first intermediate electrode.

5. The heater of claim 4, further comprising:
at least one power supplier provided to be electrically connected to the first side electrode, the second side electrode, the first intermediate electrode, and the second intermediate electrode,
wherein the at least one power supplier is configured to:
apply a voltage between the first side electrode and the second side electrode,
apply a voltage between the first side electrode and the first intermediate electrode, or
apply a voltage between the second side electrode and the second intermediate electrode.

6. The heater of claim 5, wherein the at least one power supplier is configured to:
apply a voltage between the first side electrode and the first intermediate electrode, or between the second side electrode and the second intermediate electrode, based on a first condition that is for heating the fluid at a first temperature,
apply a voltage between the first side electrode and the second side electrode, based on a second condition that is for heating the fluid at a second temperature higher than the first temperature, and
apply a voltage between the first side electrode and the first intermediate electrode, and between the second side electrode and the second intermediate electrode, based on a third condition that is for heating the fluid at a third temperature higher than the second temperature.

7. The heater of claim 1, wherein a first distance between the first side electrode and the intermediate electrode is equal to a second distance between the second side electrode and the intermediate electrode.

8. The heater of claim 1, wherein a first distance between the first side electrode and the intermediate electrode is different than a second distance between the second side electrode and the intermediate electrode.

9. The heater of claim 1,
wherein one end of the graphene scroll is disposed adjacent to a central axis of the heating flow path, which extends between the inlet and the outlet, and the graphene scroll extends from the end of the graphene scroll, so that a distance from the central axis of the heating flow path to increase, and
wherein at least a portion of the heating flow path is formed between a portion of the graphene scroll and another portion of the graphene scroll that covers the portion of the graphene scroll in an outer direction.

10. The heater of claim 9,
wherein the graphene scroll includes:
a first portion extending in a first direction from one side, which is adjacent to the end of the graphene scroll, and
a second portion extending from the first portion in the first direction,
wherein the second portion of the graphene scroll covers the first portion of the graphene scroll in the outer direction, and
wherein the at least a portion of the heating flow path is formed in a space between the first portion of the graphene scroll and the second portion of the graphene scroll.

11. The heater of claim 10, further comprising:
a spacer disposed between the first portion of the graphene scroll and the second portion of the graphene scroll and provided to maintain a space between the first portion of the graphene scroll and the second portion of the graphene scroll.

12. The heater of claim 11, wherein the spacer protrudes from the first portion of the graphene scroll toward the second portion of the graphene scroll in a direction away from the central axis of the heating flow path, and the spacer supports the second portion of the graphene scroll.

13. The heater of claim 12,
wherein the graphene scroll further includes a support layer disposed on one surface of the second portion of the graphene scroll facing the first portion of the graphene scroll, and
wherein the spacer protrudes from a portion of the support layer, which is provided in the second portion of the graphene scroll, toward the first portion of the graphene scroll in a direction toward the central axis of the heating flow path, and the spacer supports the first portion of the graphene scroll.

14. The heater of claim 1, wherein the first side electrode, the second side electrode, and the intermediate electrode each extend in a direction parallel to a direction in which the heating flow path extends between the inlet and the outlet.

15. The heater of claim 1, wherein the first side electrode, the second side electrode, and the intermediate electrode each extend in a direction parallel to a direction in which the graphene scroll extends from one end of the graphene scroll, which is disposed adjacent to a central axis of the heating flow path, toward another end of the graphene scroll.

16. The heater of claim 1, wherein a first cross-sectional area of the graphene scroll at an end adjacent to the inlet of the heating flow path is greater than a second cross-sectional area of the graphene scroll at an end adjacent to the outlet of the heating flow path.

17. The heater of claim 1, wherein the graphene scroll is formed by a graphene sheet being rolled.

18. The heater of claim 1, wherein the first side electrode, the intermediate electrode, and the second side electrode are disposed as a layer on a graphene sheet forming the graphene scroll.

19. The heater of claim 1, wherein a graphene sheet forming the graphene scroll includes a base layer and a graphene layer.

20. The heater of claim 19,
wherein the graphene sheet includes an encapsulation layer, and
wherein the graphene layer is disposed between the base layer and the encapsulation layer.
